(19) United States
(12) Patent Application Publication
(10) Pub. No.: US 2016/0350722 A1
(43) Pub. Date: Dec. 1, 2016

(54) MANAGING SCHEDULED EVENTS IN NETWORK-HOSTED TIME MANAGEMENT SYSTEM

(71) Applicant: N'8KD DECISION PTY LTD, North Ryde (AU)

(72) Inventors: Iain Summers Page Walker, North Ryde (AU); Alexander James Dalgliesh, East Ryde (AU); David James Robertson, Green Point (AU)

(73) Assignee: N'8KD DECISION PTY LTD, North Ryde (AU)

(21) Appl. No.: 15/113,952

(22) PCT Filed: Jan. 23, 2015
(86) PCT No.: PCT/AU2015/050022

§ 371 Date: Jul. 25, 2016

(30) Foreign Application Priority Data
Jan. 24, 2014 (AU) 2014900212

(51) Int. Cl. G06Q 10/10; G06F 19/00; G06F 17/30

(52) U.S. Cl. CPC G06Q 10/1095; G06F 17/30551; G06F 19/327

(57) ABSTRACT

Methods, apparatuses, and computer readable media that manage scheduled events in network-hosted time management system. Reusable non-user-specific templates, including event, notification, and associated data record stored in network-accessible database, are constructed. At least one rule is included in each template that creates temporal relationship between at least two events, or event and associated data record. Templates are instantiated by populating records with data to create a user-specific event schedule, or multiple role roster. Event notification alert temporal data is monitored, and a user device is notified by initiating a smart alert that includes a notification regarding event in a schedule requiring a reply from user device with information to satisfy the rule associated with the smart-alert. The user device receives a reply to the smart-alert to update associated data record. Based on change to data in a data record, the rule, event, data record, role and/or notification is changed.

### TECHNICAL FIELD

The present invention relates generally to electronic or computerised event management (scheduling) systems and in particular to such event management systems in a networked environment.

### BACKGROUND

Existing event management (scheduling) systems typically manage only simple static sequences of events for single or multiple users. However, such static sequences of events are not representative of real-life dynamic, recurring, and interrelated nature of events and event sequences.

While some future events and related event notifications can be predicted, existing event management systems are static and do not dynamically respond to changes to existing event schedules brought about by external influences or new event clashes when users commit to new event schedules. Furthermore, event notifications or alerts are usually unidirectional.

Existing event management systems require each user to redefine these events, schedules, and notifications each time a user uses the event, schedule, and notification. Disadvantageously, productivity losses and potential errors result because the events and the relationships between events in schedules must be redefined each time the events and the relationships between events are required.

Many events within schedules have temporal relationships with events in one or more of: other schedules of the same user, other user's schedules, and stored data records outside of schedules. These inter- and intra-schedule relationships often cause a scheduling conflict between events, resulting in some events being either delayed or ignored. Current event management systems do not cater for such more complex event relationships and resulting conflicts.

Network-accessed electronic calendaring and scheduling applications do not allow for easy integration with third party schedules. Event data is usually stored locally and not readily accessible when the users are mobile or not connected to a network. Schedule synchronising mechanisms have been found to be difficult to manage and unreliable due to the time zone differences between users and between events within schedules.

Furthermore, the control and ownership of user events and data may change over time and current systems do not allow for easy transfer ownership or sharing of control.

### SUMMARY

In accordance with an aspect of the invention, there is provided a method for managing scheduled events in a network-hosted time management system implemented using a computer system. Reusable non-user-specific templates are constructed. Each template comprises an event, a notification, and an associated data record stored in a database repository accessible via an electronic network coupled to the time management system. Each template is a combination of records in a database repository with fields that relate one record type to another record type. At least one rule included in each template. Each rule creates a temporal relationship between at least two events, or an event and an associated data record, to form at least one dynamic interrelated event schedule. Templates are instantiated by populating the records of the templates with data to create at least one user-specific event schedule, or a multiple role roster, each having associated records. Each roster is a set of interrelated event schedules for multiple user roles. Event notification alert temporal data is monitored, and at least one user device is notified by initiating a smart-alert. The smart-alert comprises a notification regarding an event in at least one schedule that requires a reply from a user device connected to the electronic network with user information to satisfy the rule associated with the smart-alert. The smart alert prompts a user to operate the at least one user device to enter data that is associated with the event for at least one of temporal relationships and an event trigger. The requested information is stored in the associated data record. A reply to the smart-alert, comprising data to update the associated data record, is received from a user device. Based on a change to data in the associated data record, a rule, an event, a role, a data record, and/or a notification is changed.

The event may be in at least one schedule of events of at least one user.

The temporal relationships defined in the templates each comprise a combination of absolute, relative, calculated, and user-defined temporal relationship.

The method may comprise recommending a template to a user based on a user attribute or activity.

The method may comprise: caching instantiated templates and associated data records in at least one local storage device of an electronic device that can access the electronic network for issuing a smart-alert when the electronic device is disconnected from the network-hosted time management system; storing a reply to the smart-alert on the local storage device until the electronic device is connected to the network-hosted time management system; and transferring the reply to the smart-alert to the network-hosted time management system.

The method may comprise modifying the timing of event notifications to cater for travel time based on a current location of a user, and time zone and location of events.

Templates and user records are adapted to be categorised, stored, searched, and viewed by system- or user-defined context specific categories and tags.

The method may comprise sharing a template and an associated data record between users using permission controls of the network-hosted time management system.

The method may comprise publishing a template by the network-hosted time management system for use by another user.

The method may comprise viewing a template and an instantiated template by the network-hosted time management system in a time-domain view or an event-relationship view.

The method may comprise displaying on a display device temporal events simultaneously as a wide time frame in summary and a shorter range of events in detail.

The method may comprise printing at least one of a template and an instantiated template.

The method may comprise allocating specific users to roster roles. The allocating may be performed automatically via predefined rules or manually.

In accordance with another aspect of the invention, there is provided an apparatus for managing scheduled events in a network-hosted time management system implemented using a computer system. The computer system comprises a processing unit and a memory storing data and a computer program. The processing unit and memory are configured when executing the computer program to perform the foregoing method.

In accordance with yet another aspect of the invention, there is provided a non-transitory computer readable medium having recorded therein a computer program for managing scheduled events in a network-hosted time management system implemented using a computer system. The computer program comprising: code for constructing reusable non-user-specific templates each comprising to an event, a notification, and an associated data record stored in a database repository accessible via an electronic network coupled to the time management system, each template being a combination of records in a database repository with fields that relate one record type to another record type; code for including, in each template, at least one rule, each rule creating a temporal relationship between at least two events, or an event and an associated data record, to form at least one dynamic interrelated event schedule; code for instantiating templates by populating the records of the templates with data to create at least one user-specific event schedule, or a multiple role roster, each having associated records, each roster being a set of interrelated event schedules for multiple user roles; code for monitoring event notification alert temporal data and notifying at least one user device by initiating a smart-alert, the smart-alert comprising a notification regarding an event in at least one schedule that requires a reply from a user device connected to the electronic network with user information to satisfy the rule associated with the smart-alert, the smart alert prompting a user to operate the at least one user device to enter data that is associated with the event for at least one of temporal relationships and an event trigger, the requested information being stored in the associated data record; code for receiving from a user device the reply to the smart-alert comprising data to update the associated data record; and code for, based on a change to data in the associated data record, changing at least one of: a rule, an event, a role, a data record, and a notification.

### BRIEF DESCRIPTION OF DRAWINGS

Embodiments of the invention are described hereinafter with reference to the accompanying drawings, in which:

FIG. 1 is a schematic diagram of a network and computing environment 100 with which various architectural components of the embodiments of the invention may be implemented;

FIG. 2 is a block diagram showing the relationships 200 between events, schedules, and rosters for single users and multiple user environments;

FIG. 3 is a simplified flowchart showing template creation 310, template instantiation 320, and smart-alerts 330;

FIG. 4 is a flowchart illustrating the workflow of notifications, including alert notifications 413 and smart-alerts user responses 412, to fixed or mobile device 410;

FIG. 5 is a block diagram illustrating instantiation from published templates 510 to user templates 520 to user instantiated templates 530 and role participation 541 for both user subscribers 550 and contact pre-subscription 570;

FIG. 6 is a flow diagram illustrating a method of managing scheduled events in a network-hosted time management system implemented using a computer system in accordance with embodiments of the invention; and

FIGS. 7A and 7B are a schematic block diagram of a general-purpose computer system with which embodiments of the invention may be practiced.

### DETAILED DESCRIPTION

Methods, apparatuses, and computer readable media for managing scheduled events in a network-hosted time management system implemented using a computer system are disclosed hereinafter. Embodiments of the invention are described with reference to the accompanying drawings, but modifications and substitutions may be made without departing from the scope of the invention. The embodiments of the invention relate to the management of user temporal events, event rules, event notifications, and associated event records and provide a means to define a schedule of events, event rules, and associated record structures so the schedule of events, event rules, and associated record structures can be replicated and reused many times by users.

Where reference is made in any one or more of the accompanying drawings to steps and/or features, which have the same reference numerals, those steps and/or features have for the purposes of this description the same function(s) or operation(s), unless the contrary intention appears.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: medicine dispensing and education timetables, amongst others. Rules can also apply across multiple users and schedules, so that multi-user schedules templates can be created for managing complex collaboration activities, such as but not limited to: rostering, meetings, and projects.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Unlike existing systems, the embodiments of the invention advantageously, provide event notifications or alerts, which are not limited to being unidirectional, provide a feedback mechanism from the user back to the event management system to request, monitor, and receive external data from users that can be used to dynamically modify event relationships, scheduled events, or future notifications. Further, the embodiments of the invention take account of the fact that many user events and event schedules are recurring in nature and therefore are suitable for reuse by the same user or other users with little or no changes.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. One embodiment of smart-alerts enables feedback and control of wearable devices such as medical monitors and medication dispensers. Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

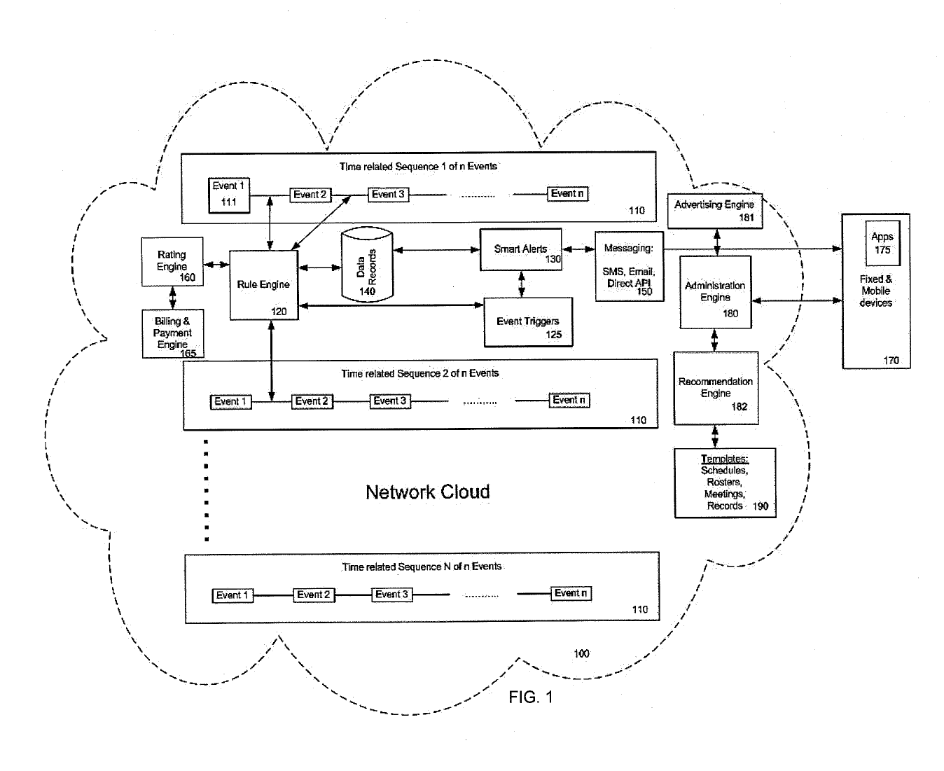

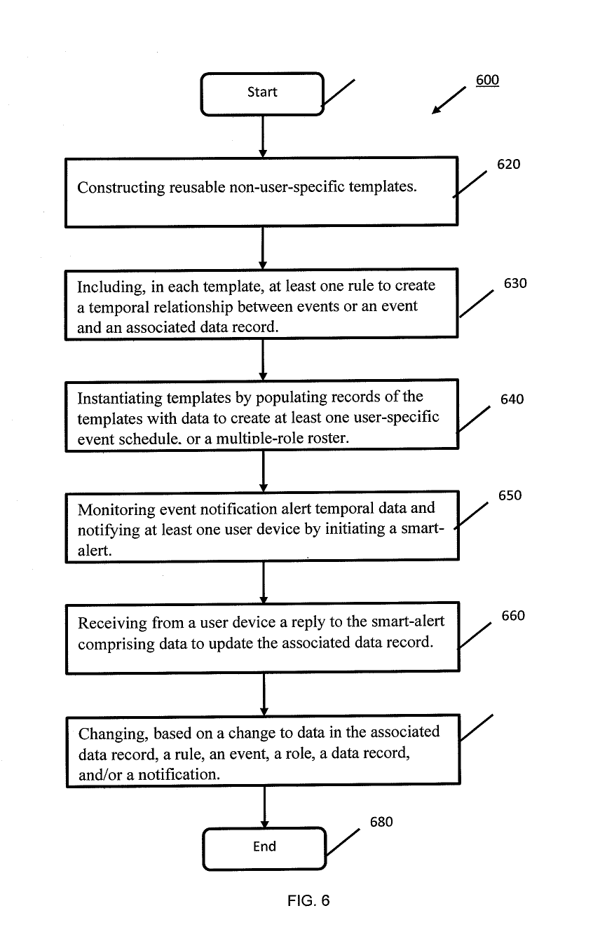

FIG. 6 illustrates at a high-level a method 600 of managing scheduled events in a network-hosted time management system implemented using a computer system in accordance with the embodiments of the invention. The method 600 commences processing at step 610 (“Start”). In step 620, reusable non-user-specific templates are constructed, as described in greater detail hereinafter with reference to FIGS. 1-5. Each template comprises an event, a notification, and an associated data record stored in a database repository accessible via an electronic network coupled to the time management system. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. In step 640, templates are instantiated by populating the records of the templates with data to create at least one user-specific event schedule, or a multiple role roster, each having associated records. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). In step 670, based on a change to data in the associated data record, a rule, an event, a role, a data record, and/or a notification is changed. Processing then ends or returns in step 680. The steps 620 to 670 may be repeatedly performed by use of an appropriate loop, or the method 600 may be repeatedly performed as required. The method 600 outlined in FIG. 6 is described hereinafter in greater detail with reference to FIGS. 1-5.

The event may be in at least one schedule of events of at least one user. The temporal relationships defined in the templates may each comprise a combination of absolute, relative, calculated, and user-defined temporal relationship.

While not shown in FIG. 6 to simplify the drawing, the method 600 may comprise recommending a template to a user based on a user attribute or activity. Furthermore, the method may comprise: caching instantiated templates and associated data records in at least one local storage device of an electronic device that can access the electronic network for issuing a smart-alert when the electronic device is disconnected from the network-hosted time management system; storing a reply to the smart-alert on the local storage device until the electronic device is connected to the network-hosted time management system; and transferring the reply to the smart-alert to the network-hosted time management system.

Optionally, the method 600 may comprise modifying the timing of event notifications to cater for travel time based on a current location of a user, and time zone and location of events.

Templates and user records may be adapted to be categorised, stored, searched, and viewed by system- or user-defined context specific categories and tags.

The method 600 may comprise sharing a template and an associated data record between users using permission controls of the network-hosted time management system. The method 600 may comprise publishing a template by the network-hosted time management system for use by another user. The method 600 may comprise viewing a template and an instantiated template by the network-hosted time management system in a time-domain view or an event-relationship view. The method 600 may comprise displaying, on a display device, temporal events simultaneously as a wide time frame in summary and a shorter range of events in detail. The method 600 may comprise printing a template and/or an instantiated template.

The method 600 may also comprise allocating specific users to roster roles. The allocation may be done automatically via predefined rules. Alternatively, the allocation may be done manually.

The method 600 may also be implemented in an apparatus for managing scheduled events in a network-hosted time management system implemented using a computer system. The computer system comprises a processing unit and a memory storing data and a computer program. The processing unit and memory are configured, when executing the computer program, to perform the method 600. A user device can communicate with the apparatus using the electronic or computer network.

The method 600 may also be implemented in a non-transitory computer readable storage medium having recorded therein a computer program for managing scheduled events in a network-hosted time management system implemented using a computer system, the computer program comprising code for implementing the steps of the method 600. These and other aspects are described with reference to the drawings hereinafter.

FIG. 1 illustrates an example of a general network and computing environment 100 in which the architectural components of the embodiments of the invention may be implemented. The network and computing environment 100 is only one example of a suitable environment and implementation and is not intended to limit the scope nor application of the embodiments of the invention. Other electronic network and computing environments, such as: private networks, intranets, etc., are also suitable environments where the embodiments of the invention may be implemented. In FIG. 1, an illustrative system for implementing one or more architectural components includes a network accessed and hosted computer system and database managing N temporal-related schedules of events 110, a rule engine 120 which manages the temporal event relationships and event triggers 125, a process to generate smart-alerts 130, a primary data storage 140 for storing records, system data and user data, a messaging server 150, a rating engine 160, a billing engine and payment gateway 165, user fixed and mobile access devices 170, mobile device specific applications (“apps”) 175, an administration engine 180, an advertising engine 181, a template recommendation engine 182, and templates 190. All the components shown in FIG. 1, except for the fixed and mobile devices 170 with apps 175, are shown within the cloud (encompassed by dashed line). The fixed and mobile devices 170 can receive messages from the messaging server 150 and can communicate with the administration engine 180.

A schedule is defined as a collection of events, roles and the rules between them. A schedule may include records that are associated with the overall schedule or with each event. An event is defined as a temporal record, which has occurred in the past or will occur in the future. An event can be shared with another user, either nominated or defined by role tags. Event creation comprises adding records and defining rules, which may depend upon record types, role tags, or any other source of dynamic data. Rules are defined as logical expressions which can trigger events, allocate roles, or result in notifications. A smart-alert is defined as a type of notification in the system, which informs or reminds a user of something, a smart-alert includes user feedback, which is used to create records.

A record is defined as a data element owned by a user of the system and comprises fields, which may contain data and media. A record may include a layout format that is either fixed or dynamic, depending upon media or information used when creating the record.

A template is defined as a record that specifies the structure of fields and the rules operating on those fields, without necessarily including the field content. There are four template types: record template, event template, schedule template and roster template. Notifications are defined as outcomes of events which are defined by rules that send electronic alerts and smart-alerts to a user.

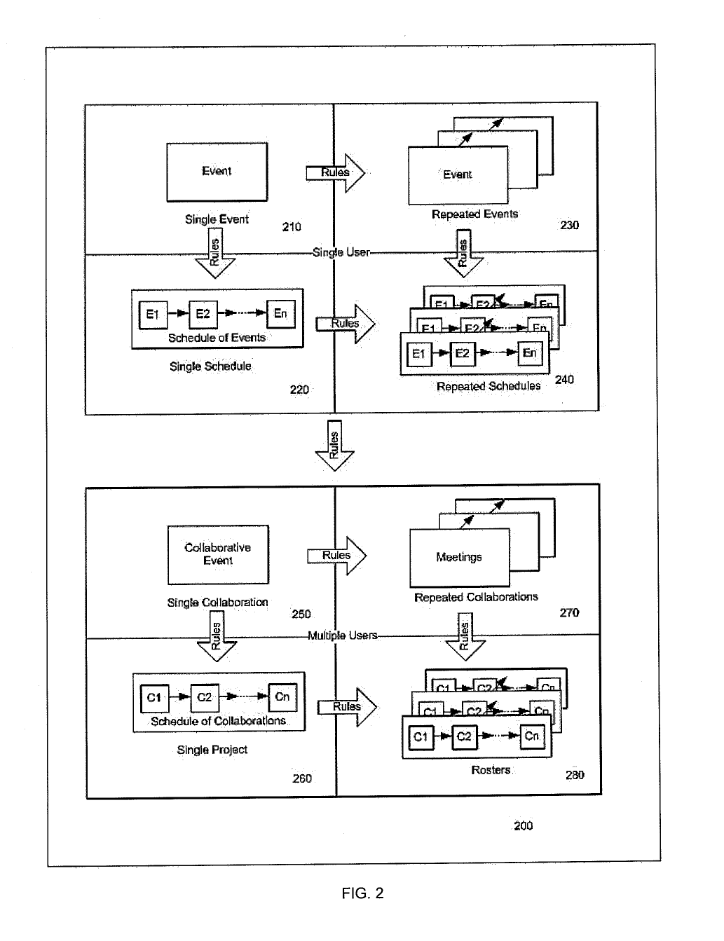

FIG. 2 illustrates the relationships amongst single temporal events 210, a schedule or sequence of events 220, repeating temporal events 230, repeating schedules of events 240 for a single user, using rules. A schedule is a sequence of single temporal events related by rules. Single temporal events can be repeated resulting in a sequence of the recurring events related by rules. A schedule of individual events can be repeated resulting in a sequence of recurring schedules related by rules. Also shown are the relationships with single collaborative events 250, a schedule of collaborative events 260, repeating collaborative events 270, and repeating schedules of collaborative events 280 using rules. Collaborative events involve multiple users. A project is a sequence of collaborative events related by rules. Collaborative events can be repeated resulting in sequence of re-occurring collaborations related by rules. A sequence of collaborative events can be repeated to form a roster, each sequence related by rules. Different users may be allocated to various events in a roster. Therefore, a roster applies to a role, not a user. Users are allocated to a role.

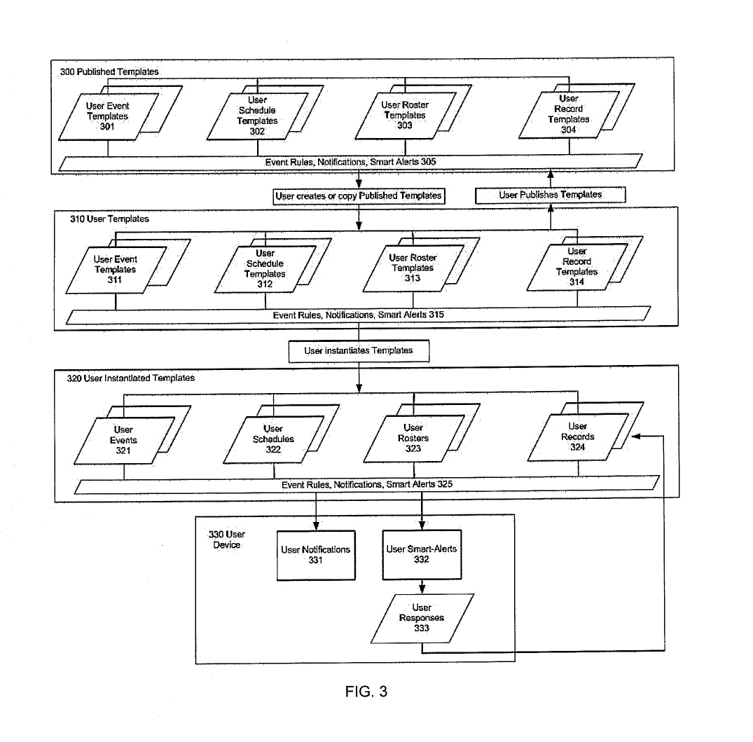

FIG. 3 is illustrates a three-tiered data schema for templates, with separate database entity structures for published templates 300, user templates 310, and user-instantiated templates 320. For network-disconnected user devices 330, the schema includes notifications 331, smart-alerts 332 and user responses 333, which are stored along with related records and processed on the local user device 330, ready to upload to the user instantiated templates 320 upon re-establishing network connectivity to the user device 330.

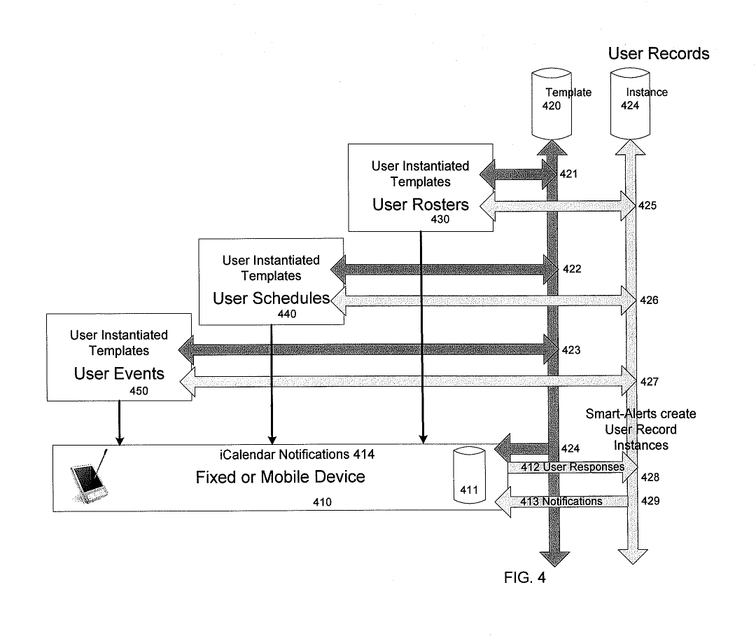

FIG. 4 illustrates the notifications received by fixed or mobile devices 410. User records 424, once instantiated, create instances of templates 420 that can be associated with user events 450, user schedules 440 and user rosters 430, as well as other records. For smart-alerts, user record templates 420 are also embedded, generating user responses 412 that are held on local storage media 411 of the device 410 or immediately uploaded 428 as a user record instance 424. For mobile devices, iCalendar notifications 414 are also provided with links to create user session and provide user responses 412 via standard electronic calendar interfaces.

A user is defined as a person who has login and password credentials and can access to the system. A roster is defined as a type of schedule that has multiple people assigned to roles associated with its event/tasks. iCalendar is a type of notification interaction with internet accessed electronic calendars, which includes interoperability guidelines as described in publications by Calconnect, the Calendaring & Scheduling Consortium. For further information, refer to the following URL: http://www.calconnect.org/CD1104_Calendaring_Standards.shtml.

Referring to FIG. 1, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

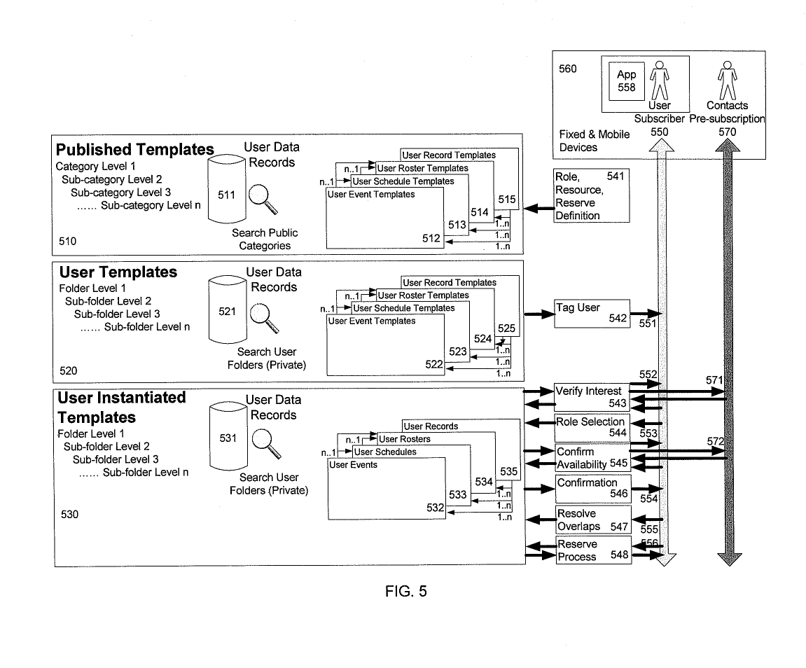

FIG. 5 illustrates the flow of transaction and activities during the process of instantiation from published templates 510 to user templates 520, and then to user instantiated templates 530 for user records templates 515, user roster templates 514, user schedule templates 513 and user event templates 512. FIG. 5 also illustrates the role, reserve, resource participation 541 interactions for user subscribers 550 and contacts if pre-subscription 570. To identify a template, search tools allow the user to search public folder categories, which hold published templates 510. User folders store both user templates 521 and user instantiated templates 531 and may be searched in the same way as categories by a user. The relationships between user record templates 515, user roster templates 514, user schedule templates 513 and user event templates 512 are also recorded. Interactions/functions are also indicated in FIG. 5, including: tag user 542; verify interest 543 by sending notifications to user subscribers 550 and enrolment invitations to contacts pre-subscription 570; role selection 544; confirm availability 545; confirmation 546; resolve overlaps 547; and reserve process 548. The combination of these interactions/functions depends upon the type of published template selected 510 and the information required at the time of instantiation 520, 530.

Template instantiation is defined as a process of creating a new copy of a template with the same rules and structure, whose empty fields can then be filled with content. Resource is defined as a facility or asset that can be allocated to an event, subject to the availability of that facility or asset. A contact is defined as either a nominated registered user or a person who is to be invited to become a registered user. A folder is defined as a user instantiated category comprising a collection of records, events, schedules, templates, and folders which are grouped together for organisational and sharing purposes.

Smart-alert responses 333 can also generate event triggers 125 to initiate other user events 321, user schedules or user rosters, either for that user or any other designated user by the rule engine 120, which processes the user instantiated templates 320.

The user device 330, also caches both user notifications 331 and user records 324, which are user generated or associated with user notifications 331 on the local storage device to allow for user notifications to be locally processed by fixed and mobile devices 170 without a connected electronic network. The embodiment involves either using existing electronic calendar interactions, or a reduced functionality version of the system 100, capable of performing reliably on suitable fixed and mobile devices 330.

Users are tracked via the administration engine 180 engine, using user information and contact lists for candidate users, which have not yet subscribed. Related information is stored in data records 140.

An unregistered user may also be recommended to enroll in the system via embedded links across the electronic network or through notifications, supervised by the administration engine 180.

Users and contacts are notified using each user's nominated messaging methods, being SMS, email, and/or direct application programming interface (API) 150, and processed by the rule engine 120 and recommendation engine 182 in FIG. 1 to generate user notifications 331 and smart-alerts 332 communicated to fixed and mobile devices 170. User preferences are supervised by the administration engine 180 and stored in data records 140 during initial user registration or at the time of updates to user preferences.

Short Message Service (SMS) was defined in 1985 as part of the Global System for Mobile Communications (GSM) series of standards as a means of sending messages of up to 160 characters to and from GSM mobile handsets.

In an embodiment of the invention, templates 190 are based upon a three-tiered data schema per FIG. 3. An alternative embodiment of the invention may use a two-tiered schema if public distribution of the published templates 300 is not required.

The top-tier published templates 300 comprise user event templates 301, user schedule templates 302, user roster templates 303, and user record templates 304.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

User record templates 304, 314 and user records 324 comprise graphical layouts, nominated media and field attributes, each stored as data records 140. User records 324 and user records templates 314, 304 may be stored with or without association with an event 210 or collaborative event 250. The top-tier published user record templates 304 can be created from a user record template 314, by identifying the fields in the template that are required to be populated with user or instantiation data at the time of instantiation, if any. Published user record templates 304 can be instantiated by a user into user template 301 versions creating user record templates 314, which in turn can be instantiated into user templates 324. To prepare for processing of templates, user data is added using available information in user records 324 to automatically populate fields required for the instantiation additional details entered by the user. Instantiation can only occur when dependent information as specified in the configuration of the template is provided by the user.

Record templates 420 and user records instances 424 are illustrated in FIG. 4, which shows the flowchart for notifications and smart-alerts in user events 450, user schedules 440 and user rosters 430. Notifications 413 of user record instances 429 are provided through transaction traffic from storage media 425, 426, 427 to the user instantiated templates of the user roster 430, user schedules 440 and user events 450 respectively. Template records comprise both public and user instantiated templates, with data that is not related to user records stored as user template data, or if not instantiated, stored in a data repository dedicated for public templates. At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

The flowchart depicted in FIG. 4 illustrates the smart-alerts notification, which includes user responses 412. Public and user records templates 420 are associated with the user instantiated templates of user rosters 430, user schedules 440, and user events 450, including instantiation data required for user entry. Transactions are notified either by standard iCalendar electronic calendar notifications or to apps or clients, which operate independently on the fixed or mobile device 410. Once the required information is entered by the user, the resulting user record instance is either locally stored 411, or providing an electronic network is available, transferred to the system user records instance 424 data storage.

Refer to FIG. 5 for details of the instantiation process for records. For published templates 510, a search is completed by specifying categories 511 or descriptive tags, allowing the user to select the most appropriate template for their needs. A user record template may include fields that are configured comprising smart-alerts user responses 333, fields which are based upon user data and filled at the time of instantiation or values that are set during processing. Public records may include information or media relevant to other records 515, or associated with user roster templates 514, user schedule templates 513 or user event templates 512. A user record template based upon user templates 520 can be converted into a published template 510 by assigning unique global identifiers for fields that are required for instantiation and configuring the user record template 515 and any other record media into the nominated category 511 for public searching. Tags and descriptive information are added to provide users with details suitable for unfamiliar users of the published-template user-record templates 515. Folders, once instantiated, can be searched using folder tags in a similar way.

A category is defined as a pre-structured publicly searchable repository for collection of records, events, schedules, templates, and categories which are grouped together for organisational and sharing purposes. A category tag, is a type of tag which describes a category, and is defined as descriptive data records that allow users to search categories based upon common use names, simplifying the cross-referencing of categories, and preserving organisational structure of categories.

A folder tag is defined as descriptive data records that allows users to search folders based upon common use names, simplifying the cross-referencing of folders, and preserving organisational structure of folders.

Data in user record templates 515 can also be utilised in rules and as smart-alert responses allowing users to update data, resulting in dynamic sequencing that can be initiated by changes in user records 535, once user instantiated templates have been created and linked to create rule field values. Role and resource tags 541 can be assigned to user subscriber records 550 to ensure that records are associated with appropriate users, with the same tags, at the time of instantiation, creating the user records 535. User-templates user-record templates 525 inherit the association links from the published templates user record templates 515. Additional user record templates 525 may be added at this time. The user record template 525 may also be associated with user roster templates 524, user schedule templates 523, and user event templates 522. The next step in the instantiation process is to collect all of the fields required for instantiation from user data records 521 if available, or request the user to add missing fields, if required, resulting in the creation of the user records 535 for dynamic run-time processing. A user can include additional user records 531 at any time by selecting existing user records 525, 535, user rosters 524, 534, related user schedules 523, 533, or user events 522, 532, automatically resulting in the storage of the new user data record 531 with inherited folder categorisation and creating a data association for that selection, therefore simplifying the record inclusion process. The system records the association between published records 510 and every user subscriber 550 that selects that published template 510 for instantiation.

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

Refer to FIG. 5 for details of the instantiation process for rosters. For published templates 510, a search is completed by specifying categories 511 or descriptive tags, allowing the user to select the most appropriate template for the user's needs. User roster templates 514 are defined as a type of schedule that includes the entire functionality comprising role, resource, reserve definition 541, tag user 542, verify interest 543, role selection 544, confirm availability 545, confirmation 546, resolve overlaps 547, and reserve process 548. Each user roster template 514 comprises user schedule templates 513, user event templates 512, and user record templates 515. Data is configured and stored in associated user record templates 515; relevant data includes user responses 333 to smart-alert, fields that are based upon user data and filled at the time of instantiation, and values that are set during processing. Rules are configured that define the interaction between user event templates 512, user schedule templates 513, and related notifications and smart-alert user responses 333. A user-roster template, based upon user templates 520, can be converted into a published template 510, in a user-nominated publicly-searchable category. The conversion is done by assigning unique global identifiers for fields that are required for instantiation and configuring the user roster templates 514 and any other record media 525, user schedule templates 523, and user event templates 522. Tags and descriptive information are added to describe the template 510 during the creation process to provide users with details suitable for unfamiliar users of the published-template user-roster templates 514.

Data in user record templates 515 can also be utilised in rules and as smart-alert responses, which allow users to update data resulting in dynamic sequencing that can be initiated by changes in user records 535 and in turn the user rosters 534 once user instantiated templates have been created and linked to create rule field values. Role and resource tags 541 can be assigned 551 to user subscriber records 550 to ensure that records are associated to appropriate users, with the same tags, at the time of instantiation, creating user records 535. User templates user roster templates 524 inherit the association links from the published templates user roster templates 514. Additional user record templates 525 may be added at this time. The next step in the instantiation process is to collect all of the fields required for instantiation from user data records 521, if available, or request the user to add missing fields, if required, resulting in the creation of user records 535 for dynamic run-time processing. For user rosters 534, the process includes verifying the interest 552 with user subscribers 550 and contacts pre-subscription 570 from contact lists, which can be entered by a user or imported as comma separated variable files, for example. Only a user subscriber 550 receives the full benefits of the system. In advance of subscription, contacts presubscription 570 may be contacted 571 by either SMS message or email to commence the invitation process to become a user subscriber 550. Once the interest is confirmed, role selection 544 can be completed by the coordinator user or automatically via the system using the role tag matching or manually.

A role tag, is a type of tag which describes a role, and is defined as a predetermined data descriptor that sets the requirement for the automatic selection of a user for a particular event where the role capability definition of the user indicates the same data descriptor.

A confirmation of availability for the role is sent 553, 572. If the contact is pre-subscription 570, an invitation is included to enroll as a user subscriber 550. User subscribers 555 can consider and resolve their overlaps 547 or conflicts in calendar commitments. Once all allocations are finalised, a confirmation 546 is sent 554 to the user. If for any reason a confirmed user is no longer available for an assigned role, the reserve process 548 is initiated. If a reserve 541 has been pre-allocated, the system automatically resolves the assignment of a reserve 556. If the assignment cannot be resolved, escalation notifications commence, notifying the coordinator user of the role vacancy. A user can include additional user records 531 at any time by selecting existing user records 525, 535 user rosters 524, 534, related user schedules 523, 533, or user events 522, 532, which automatically results in the storage of the new user data record 531 with inherited folder categorisation and creates a data association for that selection. This simplifies the record inclusion process. Published records maintain associations with the user subscriber 550 that created the template and all users that have selected the published template 510 for instantiation.

Referring to FIG. 2, for schedules 220 of events (E1, E2, . . . , En), the top-tier published user schedule templates 302 can be created from user schedule templates 312, by identifying the fields in the template that are required to be populated with user or instantiation data at the time of instantiation, if any. Users can replicate published templates 300 versions of user schedule templates 302 into user templates 310. To prepare for processing of templates, user data is added using either available information in user records 324 to automatically populate fields required for the instantiation or the user is required to enter additional data which is not available in the user records 324. Once all fields are entered, middle-tier user templates 310 versions of user schedule templates 312 are instantiated to create lower-tier user-instantiated templates 320 versions of user schedule templates 322, which are processed by the rule engine 120 and recommendation engine 182.

Refer to FIG. 5 for details of the instantiation process for schedules. For published templates 510, a search is completed by specifying categories 511 or descriptive tags, allowing the user to select the most appropriate template for the user's needs. User schedule templates 513 comprise role, resource 541, resolve overlaps 547, user event templates 512, and user record templates 515. Data is configured and stored in associated user record templates 515; relevant data includes smart-alerts user responses 333, fields which are based upon user data and filled at the time of instantiation, and values which are set during processing. Rules are configured for the interaction between user event templates 512, user schedule templates 513, and related notifications and smart-alert user responses 333. User schedule templates 513 based upon user templates 520 can be converted into a published template 510 by assigning unique global identifiers for fields that are required for instantiation and configuring the user schedule templates 513, any other record media 525, and user event templates 522 into the nominated category 511 for public searching. Tags and descriptive information are added to provide users with details suitable for unfamiliar users of the published template user schedule templates 513. Data in user record templates 515 can also be utilised in rules and as smart-alert responses, which allow users to update data resulting in dynamic sequencing that can be initiated by changes in user records 535 and in turn user schedules 533, once user instantiated templates have been created and linked to create rule field values. Role and resource tags 541 can be assigned to user subscriber records 550 to ensure that records are associated with appropriate users, with the same tags, at the time of instantiation, creating user records 535. User-templates user-schedule templates 523 inherit the association links from the published templates user schedule templates 513. Additional user record templates 525 may be added at this time. The next step in the instantiation process is to collect all of the fields required for instantiation from user data records 521, if available, or request the user to add missing fields, if required, resulting in the creation of user records 535 for dynamic run-time processing.

For user schedules 533, the process includes identifying user subscribers 550 that match tag criteria. Only a user subscriber 550 receives the full benefits of the system. In advance of subscription, contacts presubscription 570 may be contacted by either SMS message or email to commence the invitation process to become a user subscriber 550. Once the interest is confirmed, role selection 544 can be completed by the coordinator user, automatically via the system using the role tag matching, or manually. A confirmation of availability for the role 545 is completed, allowing the user to consider overlaps 547 or conflicts in calendar commitments. A user can include additional user records 531 at any time by selecting existing user records 525, 535, user rosters 524, 534, related user schedules 523, 533, or user events 522, 532, which automatically results in the storage of the new user data record 531 with inherited folder categorisation and creating a data association for that selection. This simplifies the record inclusion process. Published records maintain associations with the user subscriber 550 that created the template and all users that have selected the published template 510 for instantiation.

For events 210, the top-tier published user-schedule templates 302 can be created from a user events template 311 by identifying the fields in the template that are required to be populated with user or instantiation data at the time of instantiation, if any. Users can replicate published templates 300 versions of user event templates 301 into user templates 310. Users can replicate published templates 300 versions of user event templates 311 into user templates 310. To prepare for processing of templates, user data is added using either available information in user records 324 to automatically populate fields required for the instantiation, or the user is required to enter additional data that is not available in the user records 324. Once all fields are entered, middle-tier user templates 310 versions user event templates 311 are instantiated to create lower-tier user instantiated templates 320 version of user events templates 321. Events 210 are also associated with user records 324, which are added to published templates 300, user templates 310, or user instantiated templates 320 via a user device 300. Records associated with events 210, user notifications 331, or user responses 333 are stored either in user records 324 or locally on the user device 330 if that device is not connected to the electronic network. Once an electronic network is re-established, records added by the user on the user device 320 are transferred to user records 324, which are then processed by the rule engine 120 and recommendation engine 182.

Refer to FIG. 5 for details of the instantiation process for events. For published templates 510, a search is completed by specifying categories 511 or descriptive tags, allowing the user to select the most appropriate template for their needs. User event templates 512 comprise role, resource 541, resolve overlaps 547, and user record templates 515. Data is configured and stored in associated user record templates 515; relevant data include smart-alerts user responses 333, fields that are based upon user data and filled at the time of instantiation, and values that are set during processing. Rules are configured for the interaction between user event templates 512, user schedule templates 513, and related notifications and smart-alert user responses 333. User event templates 512 based upon user templates 520 can be converted into a published template 510 by assigning unique global identifiers for fields that are required for instantiation and configuring the user event templates 512 and any other record media 525 into the nominated category 511 for public searching. Tags and descriptive information are added to provide users with details suitable for unfamiliar users of the published template user event templates 512. Data in user record templates 515 can also be utilised in rules and as smart-alert responses, which allow users to update data resulting in dynamic sequencing that can be initiated by changes in user records 535 and in turn user events 532, once user instantiated templates have been created and linked to create rule field values. Role and resource tags 541 can be assigned to user subscriber records 550 to ensure that records are associated with appropriate users, with the same tags, at the time of instantiation, creating the user records 535. User-templates user event templates 522 inherit the association links from the published templates user event templates 512. Additional user record templates 525 may be added at this time. The next step in the instantiation process is to collect all of the fields required for instantiation from user data records 521, if available, or request the user to add missing fields, if required, resulting in the creation of user records 535 for dynamic run-time processing.

For user events 532, the process includes identifying user subscribers 550 that match tag criteria. Only a user subscriber 550 receives the full benefits of the system. In advance of subscription, contacts presubscription 570 may be contacted by either SMS message or email to commence the invitation process to become a user subscriber 550. Once the interest is confirmed, role selection 544 can be completed by the coordinator user, automatically via the system using the role tag matching, or manually. A confirmation of availability for the role 545 is completed, allowing the user to consider overlaps 547 or conflicts in calendar commitments. A user can include additional user records 531 at any time by selecting existing user records 525, 535 user rosters 524, 534, related user schedules 523, 533, or user events 522, 532, automatically resulting in the storage of the new user data record 531 with inherited folder categorisation and creating a data association for that selection. This simplifies the record inclusion process. Published records maintain associations with the user subscriber 550 that created the template and all users that have selected the published template 510 for instantiation.

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The rule engine 120 processes the configuration information stored as attributes of rules located in data records which define the various temporal relationships. The rule types define temporal relationships in templates which use smart-alert responses, other event 532 outcomes, scheduled times or machine states to dynamically create triggers that adjust event relationships.

The rating engine 160 processes user actions, the processing overhead, and the volume of stored user data records 140. User subscription levels define entitlements, and if limits are exceeded, the rating engine 160 generates events, which propose subscription upgrades to users. Rating entitlements for groups of users are also tracked and managed by the rating engine 160.

The billing & payment engine 165 shown in FIG. 1 processes subscription events, which are managed by the rating engine 160 to collect user payments.

The advertising engine 181 of FIG. 1 tracks metadata relating to users and completes analysis of user demographics to support targeted advertising. An advertising interface is also managed by the advertising engine 181 to utilise areas of the display on fixed and mobile user devices 170.

The embodiments of the invention have application to, but are not limited to, medication management and academic schedules, for example. In both cases, important information and media is loaded into the data records 140 repository. If updates of this information are needed, user templates 310 and published templates 300 can be created. Events 210 are configured individually or as schedules 220. Additional users, such as a carer for medications, or other student users in a student project can be established as a single collaboration 250, repeated collaboration 270, project 260 or roster 280. For the medication administration (an example of a “medication event”) of a child, a parent can be provided with the full control of the user account for that child. The parent can also transfer the control of the account for a period of time or perpetually using the administration engine 180.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence of medications is established by using an event 111 for each medication, which may be repeated, or dynamically sequenced depending upon other events for the user or another user. A carer may be notified by the recommendation engine 182 if for any reason user responses 333 are not received in accordance with each rule 100.

For a group of students, for example, all students can be provided with user notifications 331 to remind the students of their role, important actions, distribution and collection of records 324 and prompt the students for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For medication management, a protocol for one prescription medication created for one user can be used by many users across future periods of time. This ensures that patients are advised of user notification 331. Using smart-alerts 332 and user responses 333 received by fixed and mobile devices 170, patients are able to collect and log important information. Relevant examples of such information include test results, reports, dates of expiry of medications, symptoms, pain levels, date of next appointment, amount of stock of medication at hand, and dates that prescriptions are required to ensure that prescribed medications are not disrupted. An event 210 or schedule 220 can also be configured for interacting with medications, e.g. to track the maximum period that medication can be administered, and adjusting dosages depending on rule interactions. Schedules 220 and records 324 can be searched by the user and shared with health professionals or any other user, either on a temporary or perpetual basis.

For academic schedules, the system is able to track the location of the users fixed and mobile devices 170. Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, a phone conference can be scheduled for participants in different time zones, ensuring that each participant's user notifications 331 are adjusted for time of day across the varying time zones.

Temporal relationships defined in the templates each comprises a combination of absolute, relative, calculated, and user-defined temporal relationship.

The rule engine 120 processes the configuration information stored as attributes of rules located in data records, where the rules define the various temporal and role allocation relationships. Further, the rule types define the following:

rules between events 111,

rules between different sequences of events 110,

rules based upon data records 140,

rules based upon user data 324,

rules which manage role allocation,

rules based upon user responses 333,

rules which rely upon the recommendation engine 182,

rules to define user notifications 331,

rules to define user smart-alerts 332, and

rules to respond to user responses 333.

Rule attributes comprise input variables for simple processing algorithms that generate a Boolean outcome. Rules are configured whenever selecting an event 210 to create repeated events 230, a single schedule 220, or repeated schedules 240. Rules also allow for the selection of user roles associated with a collaborative event 250, a schedule of collaborations 260, or repeated collaborations 270 or rosters 280. Interactions with users are processed by the recommendation engine 182.

Input variables comprise user records 324, role allocation and contact tags, smart-alert user responses 333, and/or outcomes generated by other event triggers 125 relating to events 111, either triggered by users or any other source including machine status or time initiated events.

The recommendation engine 182 can recommend templates 510 to users based upon criteria comprising:

selection of user attributes recorded in records 535,

category and folder description or tags 544 identified based upon user search criteria,

invitations 543, 546 from co-ordinating users, or

other sources such as embedded URL links in social media or web advertising, which result in the pre-selection of application landing pages and pre-selection of templates 510 of interest to a user.

User devices 330 also cache both user notifications 331 and user records 324 on a local storage device to allow for user notifications to be locally processed without a connected electronic network. User records 324 may be user generated or associated with user notifications 331, such as smart-alert responses. This embodiment involves either using existing electronic calendar functionality combined with system managed interactions via the connected electronic network, or a reduced functionality version of the system 100, capable of performing reliably on suitable fixed and mobile devices 330 when an electronic network is not available.

Similarly, user responses to smart-alerts 333, comprising the entry of data or acknowledgements as stored on user devices 330 that are not connected to an electronic network, are cached on that user device and then transferred to user data records 515 when a data connection via an electronic network to that device is next available.

A user device may connect automatically via fixed or local WLAN electronic networks, or can be manually connected using a wireless carrier's electronic network.

User instantiated templates including user events 532, user schedules 533, and user rosters 534 may include an event 532 that dynamically adjusts for travel time based on a current location of a user, time zone and location of events, and the intended time and location of a dependent event 532. Third party travel time servers can be integrated via an electronic network to identify the transit time that applies depending upon the mode of transit, including: walking, pedal bicycle, motor vehicle, public transport, domestic or international air travel. Adjustments are also made if no transit time is required, as may be the case for a phone based teleconference.

Published templates 510, user templates 520, and user records in user instantiated templates 520 are categorised, stored, searched, and viewed by the system or user-defined context specific categories and tags. Published templates 510 have system defined categories and tags that can be replicated by users at the time of instantiation, converting from the published template 510 into the user template 520. A user's folder structure can default to the same structure of the published template 510 category or may be user defined at the time of instantiation, or anytime thereafter.

A user may share a published template 510 or user template 520 and any user instantiated templates 530 and any associated user data record 531. User data records comprise user events 532, user schedule 533, user rosters 534, or user records 535. Users may share user data records 521, 531 with any other user subscriber, based upon a single selection of a record, or based upon a folder, which may include sub-folders depending upon the user selection. Sharing may be either perpetual, or for a defined period.

Another type of sharing occurs when a co-ordinating user includes an unsubscribed contact. This results in that unsubscribed contact being notified, by either SMS or email 150, to become a subscriber of the system. A subscriber must enter required user data records 531 and thereafter receives system notifications to enrolled fixed and mobile devices 170.

A user may request to create published templates 510. The process of creating a published template comprises: selecting an existing user template 520, defining the user records that must be defined at the time of instantiation of the published template 510 once created, and approving the template by a system administrator as being suitable for publication. The process also includes nominating a public category and defining descriptive information relating to that template and any tags that may be searched by users 511. Once published, any system user may select that template and, providing the user has defined the user data records 511 required for instantiation, that user then creates their own unique version of a user template 520. The relationship between the source published template 510 and the user template 520 is traced by the system to allow for user notification of changes to published templates, if in the future those templates are adjusted.

Published templates 510, user templates 520, and user instantiated templates 530 may be viewed in either a time-domain view, or in a view based upon event-relationships. The published templates 510, user templates 520, and user instantiated templates 530 comprise user event templates 512, 522 and user events 532, user schedule templates 513, 523 and user schedules 533, user roster templates 514, 524 and user roster 534.

The time-domain views may comprise daily, weekly, monthly, six monthly, annual, and multi-year periods. Event relationships are illustrated by displaying configuration fields that define start time, end time, records, and rules that define interactions between events 305, 315, 325 and the types of alert and smart-alert notifications 513.

A combined display of both time domain and event-relationship views may also be practiced.

The display on each user's fixed or mobile device 170 can illustrate the details of temporal events for defined shorter periods simultaneously as extended time frames are displayed in summary. Details may be displayed for daily-, weekly-, and monthly-scheduled events, along with monthly, six-monthly, annual, and multi-year periods. Each of the day, weekly, monthly and six-monthly views can be scrolled to increment or decrement each day, week, month, or six-month period respectively.

A user may output a printed document or file “output” suitable for electronic distribution of all of the information and details included in each user instantiated template 530, user template 520, and published template 510. The output may include a summary section, as well as sections for each user data record 511, 521, 531 that include all definitions 541 rules 305, fields and attributes stored in user records 324, allocated categories and folders, tag 542, contact 570, user list 550, availability 545, confirmation 546, verification of interest 543 (as applicable) for each record 511, 521, 531 along with printed copies of details of each user records 535 and user record templates 515, 525.

Thus, the embodiments of the invention provide network hosted service for managing temporal data such as: anniversaries, appointments, event schedules, rosters, meetings, and associated record management driven by reusable and editable templates, rules, triggers, and smart-alerts.

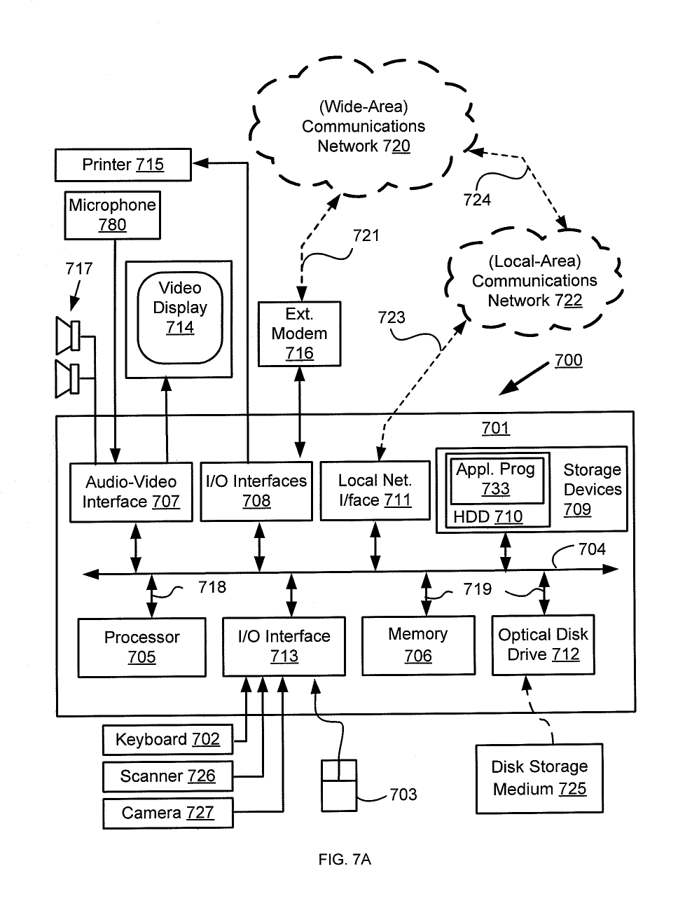

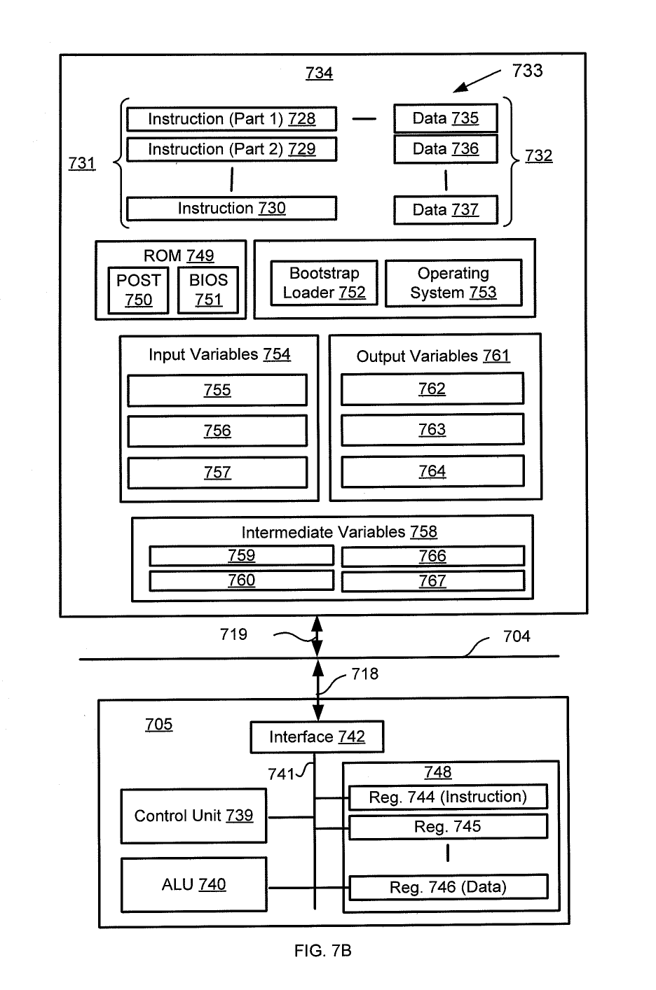

The computer system implementing the time management system may be practiced using the computer system 700 depicted in FIG. 7. Similarly, the local devices, user devices, and the like electronic devices may be implemented using an architecture like that in FIG. 7 with appropriate modifications (e.g., smart phones, electronic tablets, etc.) In particulars, FIGS. 7A and 7B depict a general-purpose computer system 700, upon which the various arrangements described can be practiced.

As seen in FIG. 7A, the computer system 700 includes: a computer module 701; input devices such as a keyboard 702, a mouse pointer device 703, a scanner 726, a camera 727, and a microphone 780; and output devices, including a printer 715, a display device 714 and loudspeakers 717. An external Modulator-Demodulator (Modem) transceiver device 716 may be used by the computer module 701 for communicating to and from a communications network 720 via a connection 721. The communications network 720 may be a wide-area network (WAN), such as the Internet, a cellular telecommunications network, or a private WAN, for example. Where the connection 721 is a telephone line, the modem 716 may be a traditional “dial-up” modem. Alternatively, where the connection 721 is a high capacity (e.g., cable) connection, the modem 716 may be a broadband modem. A wireless modem may also be used for wireless connection to the communications network 720.

The computer module 701 typically includes at least one processor unit 705, and a memory unit 706. For example, the memory unit 706 may have semiconductor random access memory (RAM) and semiconductor read only memory (ROM). The computer module 701 also includes a number of input/output (I/O) interfaces including: an audio-video interface 707 that couples to the video display 714, loudspeakers 717 and microphone 780; an I/O interface 713 that couples to the keyboard 702, mouse 703, scanner 726, camera 727 and optionally a joystick or other human interface device (not illustrated); and an interface 708 for the external modem 716 and printer 715. The modem 716 may be incorporated within the computer module 701, for example within the interface 708. The computer module 701 also has a local network interface 711, which permits coupling of the computer system 700 via a connection 723 to a local-area communications network 722, known as a Local Area Network (LAN). As illustrated in FIG. 7A, the local communications network 722 may also couple to the wide network 720 via a connection 724, which would typically include a so-called “firewall” device or device of similar functionality. The local network interface 711 may comprise an Ethernet circuit card, a Bluetooth® wireless arrangement or an IEEE 802.11 wireless arrangement; however, numerous other types of interfaces may be practiced for the interface 711.

The I/O interfaces 708 and 713 may afford either or both of serial and parallel connectivity, the former typically being implemented according to the Universal Serial Bus (USB) standards and having corresponding USB connectors (not illustrated). Storage devices 709 are provided and typically include a hard disk drive (HDD) 710. Other storage devices such as a floppy disk drive and a magnetic tape drive (not illustrated) may also be used. An optical disk drive 712 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 700.

The components 705 to 713 of the computer module 701 typically communicate via an interconnected bus 704 and in a manner that results in a conventional mode of operation of the computer system 700 known to those in the relevant art. For example, the processor 705 is coupled to the system bus 704 using a connection 718. Likewise, the memory 706 and optical disk drive 712 are coupled to the system bus 704 by connections 719. Examples of computers on which the described arrangements can be practised include IBM-PC's and compatibles, Sun Sparcstations, Apple Mac or a like computer systems.

The method of managing scheduled events in a network-hosted time management system may be implemented using the computer system 700 where the processes of FIGS. 1-6 may be implemented as one or more software application programs 733 executable within the computer system 700. In particular, the steps of the method of managing scheduled events in a network-hosted time management system are effected by instructions 731 (see FIG. 7B) in the software 733 that are carried out within the computer system 700. The software instructions 731 may be formed as one or more code modules, each for performing one or more particular tasks. The software may also be divided into two separate parts, in which a first part and the corresponding code modules performs the method of managing scheduled events in a network-hosted time management system and a second part and the corresponding code modules manage a user interface between the first part and the user.

The software may be stored in a computer readable medium, including the storage devices described below, for example. The software is loaded into the computer system 700 from the computer readable medium, and then executed by the computer system 700. A computer readable medium having such software or computer program recorded on the computer readable medium is a computer program product. The use of the computer program product in the computer system 700 preferably effects an advantageous apparatus for managing scheduled events in a network-hosted time management system.

The software 733 is typically stored in the HDD 710 or the memory 706. The software is loaded into the computer system 700 from a computer readable medium, and executed by the computer system 700. Thus, for example, the software 733 may be stored on an optically readable disk storage medium (e.g., CD-ROM) 725 that is read by the optical disk drive 712. A computer readable medium having such software or computer program recorded on it is a computer program product. The use of the computer program product in the computer system 700 preferably effects an apparatus for managing scheduled events in a network-hosted time management system.

In some instances, the application programs 733 may be supplied to the user encoded on one or more CD-ROMs 725 and read via the corresponding drive 712, or alternatively may be read by the user from the networks 720 or 722. Still further, the software can also be loaded into the computer system 700 from other computer readable media. Computer readable storage media refers to any non-transitory tangible storage medium that provides recorded instructions and/or data to the computer system 700 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 701. Examples of transitory or non-tangible computer readable transmission media that may also participate in the provision of software, application programs, instructions and/or data to the computer module 701 include radio or infra-red transmission channels as well as a network connection to another computer or networked device, and the Internet or intranets including e-mail transmissions and information recorded on Websites and the like.

The second part of the application programs 733 and the corresponding code modules mentioned above may be executed to implement one or more graphical user interfaces (GUIs) to be rendered or otherwise represented upon the display 714. Through manipulation of typically the keyboard 702 and the mouse 703, a user of the computer system 700 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 717 and user voice commands input via the microphone 780.

FIG. 7B is a detailed schematic block diagram of the processor 705 and a “memory” 734. The memory 734 represents a logical aggregation of all the memory modules (including the HDD 709 and semiconductor memory 706) that can be accessed by the computer module 701 in FIG. 7A.

When the computer module 701 is initially powered up, a power-on self-test (POST) program 750 executes. The POST program 750 is typically stored in a ROM 749 of the semiconductor memory 706 of FIG. 7A. A hardware device such as the ROM 749 storing software is sometimes referred to as firmware. The POST program 750 examines hardware within the computer module 701 to ensure proper functioning and typically checks the processor 705, the memory 734 (709, 706), and a basic input-output systems software (BIOS) module 751, also typically stored in the ROM 749, for correct operation. Once the POST program 750 has run successfully, the BIOS 751 activates the hard disk drive 710 of FIG. 7A. Activation of the hard disk drive 710 causes a bootstrap loader program 752 that is resident on the hard disk drive 710 to execute via the processor 705. This loads an operating system 753 into the RAM memory 706, upon which the operating system 753 commences operation. The operating system 753 is a system level application, executable by the processor 705, to fulfil various high level functions, including processor management, memory management, device management, storage management, software application interface, and generic user interface.

The operating system 753 manages the memory 734 (709, 706) to ensure that each process or application running on the computer module 701 has sufficient memory in which to execute without colliding with memory allocated to another process. Furthermore, the different types of memory available in the system 700 of FIG. 7A must be used properly so that each process can run effectively. Accordingly, the aggregated memory 734 is not intended to illustrate how particular segments of memory are allocated (unless otherwise stated), but rather to provide a general view of the memory accessible by the computer system 700 and how such is used.

As shown in FIG. 7B, the processor 705 includes a number of functional modules including a control unit 739, an arithmetic logic unit (ALU) 740, and a local or internal memory 748, sometimes called a cache memory. The cache memory 748 typically includes a number of storage registers 744-746 in a register section. One or more internal busses 741 functionally interconnect these functional modules. The processor 705 typically also has one or more interfaces 742 for communicating with external devices via the system bus 704, using a connection 718. The memory 734 is coupled to the bus 704 using a connection 719.

The application program 733 includes a sequence of instructions 731 that may include conditional branch and loop instructions. The program 733 may also include data 732 which is used in execution of the program 733. The instructions 731 and the data 732 are stored in memory locations 728, 729, 730 and 735, 736, 737, respectively. Depending upon the relative size of the instructions 731 and the memory locations 728-730, a particular instruction may be stored in a single memory location as depicted by the instruction shown in the memory location 730. Alternately, an instruction may be segmented into a number of parts each of which is stored in a separate memory location, as depicted by the instruction segments shown in the memory locations 728 and 729.

In general, the processor 705 is given a set of instructions which are executed therein. The processor 705 waits for a subsequent input, to which the processor 705 reacts to by executing another set of instructions. Each input may be provided from one or more of a number of sources, including data generated by one or more of the input devices 702, 703, data received from an external source across one of the networks 720, 702, data retrieved from one of the storage devices 706, 709 or data retrieved from a storage medium 725 inserted into the corresponding reader 712, all depicted in FIG. 7A. The execution of a set of the instructions may in some cases result in output of data. Execution may also involve storing data or variables to the memory 734.

The disclosed arrangements use input variables 754, which are stored in the memory 734 in corresponding memory locations 755, 756, 757. The arrangements produce output variables 761, which are stored in the memory 734 in corresponding memory locations 762, 763, 764. Intermediate variables 758 may be stored in memory locations 759, 760, 766 and 767.

Referring to the processor 705 of FIG. 7B, the registers 744, 745, 746, the arithmetic logic unit (ALU) 740, and the control unit 739 work together to perform sequences of micro-operations needed to perform “fetch, decode, and execute” cycles for every instruction in the instruction set making up the program 733. Each fetch, decode, and execute cycle comprises: a fetch operation, which fetches or reads an instruction 731 from a memory location 728, 729, 730; a decode operation in which the control unit 739 determines which instruction has been fetched; and an execute operation in which the control unit 739 and/or the ALU 740 execute the instruction.

Thereafter, a further fetch, decode, and execute cycle for the next instruction may be executed. Similarly, a store cycle may be performed by which the control unit 739 stores or writes a value to a memory location 732.

Each step or sub-process in the processes of FIGS. 1-6 is associated with one or more segments of the program 733 and is performed by the register section 744, 745, 747, the ALU 740, and the control unit 739 in the processor 705 working together to perform the fetch, decode, and execute cycles for every instruction in the instruction set for the noted segments of the program 733.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed The foregoing discloses several embodiments of the invention, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: immunisations applicable from birth. Recommendations for this example are based on at least one of, national, state and local jurisdiction health-related requirement and a health advisory body recommendation.

Examples of a health advisory body include medical specialists, health insurance providers, health care centres and organisations such as the World Health Organization (WHO), a specialist agency of the United Nations Development Group, which provides guidance to governments on setting policy for immunisation schedules which then apply to each government's jurisdiction.

This example includes user profile and other information and circumstances related to the specific aspects of sub-groups in the community of users, including the geographic location of the user community and may relate to the specific requirements related to national, state or local jurisdiction. This embodiment also encapsulates related embodiments including templates for community health care, and may also combine the health checks schedule example in a single embodiment.

Referring to FIG. 6 for immunisations, the method 600 uses events and timing information which is advised by health administrators and health advisors as applicable to each user's location. The method 600 commences processing at step 610 (“Start”). In step 620, reusable non-user-specific templates are constructed by users, including health administrators and health advisors, as described in greater detail hereinafter with reference to FIGS. 1-5. Each template comprises for each immunisation an event, a notification, and an associated data record stored in a database repository accessible via an electronic network coupled to the time management system. Examples of records include date of birth, gender, demographic information, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between immunisations, particularly when events are missed, and there is a pre-determined constraint on administering further immunisations or any sequence of events that requires definition such as repeats or any other specific periods between those events. In step 640, templates are instantiated by populating the records of the templates with data to create at least one user-specific event schedule, or a multiple role roster, each having associated records. For immunisations, rosters may be used to manage the health pathway interaction between healthcare professionals as well as the involvement of the patient's nurse, family, friend, advocate or carer. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the immunisation embodiment, records include date of birth, gender, demographic information, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's immunisation requirement. The steps 620 to 670 may be repeatedly performed by use of an appropriate loop, or the method 600 may be repeatedly performed as required. The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: vaccinations, immunisations, health checks to determine requirements, family nurse evaluations, briefings on symptoms, advise of media and related information, request for user details, request for records relating to each of those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: vaccinations, inoculations, immunisations, health checks to determine requirements, family nurse evaluations, briefings on symptoms, advise of media and related information, request for user details, request for records relating to each of those events in the schedule

Examples of records include birth date, gender, address, location of the mobiles device, health status, immunisation certificates, prescriptions, medical reports, health insurance claims, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: vaccinations, inoculations, immunisations, health checks to determine requirements, family nurse evaluations, briefings on symptoms, advise of media and related information, request for user details, request for records relating to each of those events in the roster

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, immunisations, community health care, personal development monitoring, health checks and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for immunisations is established by using an event 111 for each scheduled activity, which may be repeated, or dynamically sequenced depending upon other events for the user or another user. A carer, guardian, schedule creator or other user may be notified by the recommendation engine 182 if for any reason user responses 333 are not received in accordance with each rule 100.

For a health administrator, for example, a schedule can be created so that all participants are provided with user notifications 331 to remind them of their important actions, preparations, distribution and collection of records 324 and prompt each role for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For immunisations, a health plan created by health administrators for typical users based upon standard advice published by the peak industry body applicable to that location or jurisdiction. This can be used by many parents for children, each with their own profile. The schedule is then available for future users over future periods of time. This ensures that each user, or their parent or guardian if applicable, is advised of user notifications 331. Using smart-alerts 332 and user responses 333 received by fixed and mobile devices 170, users are able to adjust the standard schedule to match their profile, as well as collect and log important information. Relevant examples of such information include information on the immunisation as scheduled, preparation, confirmation of appointments, related health checks such as baby health care review, adding of reports, details required for health care claims, and dates that other related tasks need to conducted, such as confirmation of available times. An event 210 or schedule 220 can also be configured for interacting with each planned immunisation e.g. for where there are follow-on procedures relating to test results, changes in health care advice specific to each user, allergy treatment, alternative inoculation, and other specific treatments which may depend upon health care policies, user responses and the user's profile. Schedules 220 and records 324 can be searched by the user and shared with between parents, guardian or other users and health professionals or any other user, either on a temporary or perpetual basis.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for immunisations planning or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment of the patent in immunisations planning and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: health checks planning relating to the date of birth, gender and other user profile information. This embodiment may also combine the immunisations schedule example in a single embodiment.

Recommendations for health checks planning may be based on at least one of, national, state and local jurisdiction health-related requirement and a health advisory body recommendation.

Examples of a health advisory body include medical specialists, health insurance providers, health care centres, any other source of health and well-being advice, and organisations such as the World Health Organization (WHO), a specialist agency of the United Nations Development Group, which provides guidance to governments on setting policy for immunisation schedules which then apply to each government's jurisdiction.

Referring to FIG. 6 for health checks plans, the method 600 uses events and timing information which is advised by health administrators and health advisors as applicable to each user's location. The method 600 commences processing at step 610 (“Start”). In step 620, reusable non-user-specific templates are constructed by users, including health administrators and health advisors, as described in greater detail hereinafter with reference to FIGS. 1-5. Each template comprises for each health check an event, a notification, and an associated data record stored in a database repository accessible via an electronic network coupled to the time management system. Examples of records include date of birth, gender, demographic information, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between health checks, particularly when events are missed, and there is a pre-determined constraint on when the next related health check is recommended or any sequence of events that requires definition such as repeats or any other specific periods between those events. In step 640, templates are instantiated by populating the records of the templates with data to create at least one user-specific event schedule, or a multiple role roster, each having associated records. For health checks, rosters may be used to manage the health pathway interaction between healthcare professionals as well as the involvement of the patient's nurse, family, friend, advocate or carer. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the health check embodiment, records include date of birth, gender, demographic information, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's health care plan. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: the standard recommended health checks, courses of actions relating to the preparation of health checks, briefings on symptoms, advise of media and related information, request for user details, request for records relating to each of those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: standard recommended health checks, courses of actions relating to the preparation of health checks, briefings on symptoms, advise of media and related information, request for user details, request for records relating to each of those events in the schedule

Examples of records include birth date, gender, address, location of the user's mobile device, health status, immunisation certificates, doctor's reports, prescriptions, medical reports, health insurance claims, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: standard recommended health checks, courses of actions relating to the preparation of health checks, briefings on symptoms, advise of media and related information, request for user details, request for records relating to each of those events in the roster

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, immunisations, community health care, personal development monitoring, health checks and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for health checks is established by using an event 111 for each scheduled activity, which may be repeated, or dynamically sequenced depending upon other events for the user or another user. A carer, guardian, schedule creator or other user may be notified by the recommendation engine 182 if for any reason user responses 333 are not received in accordance with each rule 100.

For a health administrator, for example, a schedule can be created so that all participants are provided with user notifications 331 to remind them of their important actions, preparations, distribution and collection of records 324 and prompt each role for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For health checks, a health plan created for typical users based upon standard advice published by the health care industry. This can then be used by many users across future periods of time. This ensures that each user is advised of user notifications 331. Using smart-alerts 332 and user responses 333 received by fixed and mobile devices 170, users are able to adjust the standard schedule to match their profile, as well as collect and log important information. Relevant examples of such information include information on the health check as scheduled, preparation, confirmation of meetings, adding of reports, details required for health care claims, and dates that other related tasks need to conducted, such as confirmation of available times, and completion of related health care activities such as pathology and radiology. An event 210 or schedule 220 can also be configured for interacting with each planned health check e.g. for where there are follow-on procedures relating to test results, changes in health care advice specific to each user, and other health prevention schedules. Schedules 220 and records 324 can be searched by the user and shared with other users and health professionals or any other user, either on a temporary or perpetual basis.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for health checks planning or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment of the patent in health checks planning and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: therapy management for the various related roles including patient, dependent, carer, nurse, clinician, clinical facility, This embodiment also encapsulates related embodiments including events for medication, therapy preparation, therapy execution, post-operative therapy, inpatient or outpatient services.

Referring to FIG. 6 for therapy management, the method 600 uses events and timing information which is advised by healthcare providers and related health and well being advisors as applicable to each user's specific need. The method 600 commences processing at step 610 (“Start”). In step 620, reusable non-user-specific templates are constructed by users, including administrators, advisors, carer or user, as described in greater detail hereinafter with reference to FIGS. 1-5. Each template comprises for each health therapy an event, a notification, and an associated data record stored in a database repository accessible via an electronic network coupled to the time management system. Examples of records include date of preparation for that therapy, date of consultation, information related to the progression of events for that therapy, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progressions of events for that therapy, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For therapies, rosters may be used to manage the health pathway interaction between healthcare and wellness professionals as well as the involvement of the patient's nurse, family, friend, advocate, therapy or wellness community or carer. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the therapy and wellness embodiment, records include date of consultation, information related to the progression of events for that therapy, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's care plan. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: management of medication, preparation for a therapy, the execution of a therapy, inpatient process, outpatient process, fitness and other health prevention programs, surgical dressings, pain management, recovery procedures, meeting schedules relating to a therapy, dietary advice. Specific therapy management examples include pre-operative management, post-operative management, admission preparation, discharge preparation, carer management, nursing procedures, patient review processes, holistic medicine planning, consumer self-care, remote care management, collaborations of health care participants and managing life transitions as may be appropriate when a person requires a carer to take over in-home care, or when a patient is admitted to a facility for their future healthcare requirements, as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses at the time of notification. As well, smart-alerts enable feedback and control of wearable devices such as medical monitors and medication dispensers.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: management of medication, preparation for a therapy, the execution of a therapy, inpatient process, outpatient process, fitness, health prevention programs, changing of surgical dressings, pain management, recovery procedures, meeting schedules relating to a therapy, dietary advice, pre-operative management, post-operative management, admission preparation, discharge preparation, carer management, nursing procedures, patient review processes, holistic medicine planning, consumer self-care, remote care management, collaborations of health care participants as per those events in the schedule

Examples of records include birth date, gender, address, location of the user's mobile device, health care identifier, insurance provider, health status, immunisation certificates, doctor's reports, prescriptions, medical reports, health insurance claims, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: management of medication (for example, medication events including the administration or/or taking of a medication), preparation for a therapy, the execution of a therapy, inpatient process, outpatient process, fitness, health prevention programs, changing of surgical dressings, pain management, recovery procedures, meeting rosters relating to a therapy, dietary advice, pre-operative management, post-operative management, admission preparation, discharge preparation, carer management, nursing procedures, patient review processes, holistic medicine planning, consumer self-care, remote care management, collaborations of health care participants as per those events in the roster

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, management of medication, preparation for a therapy (an example of a “therapy event”), the execution of a therapy (an example of a “therapy event”), inpatient process, outpatient process, fitness, health prevention programs, changing of surgical dressings, pain management, recovery procedures, meeting rosters relating to a therapy, dietary advice, pre-operative management, post-operative management, admission preparation, discharge preparation, carer management, nursing procedures, patient review processes, holistic medicine planning, consumer self-care, remote care management, collaborations of health care participant and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for therapy management is established by using an event 111 for each scheduled activity (that is, each of a plurality of therapy events), which may be repeated, or dynamically sequenced depending upon other events for the user or another user. A carer, guardian, nurse or medical professional may be notified by the recommendation engine 182 if for any reason user responses 333 are not received in accordance with each rule 100.

For a health care team, for example, all participants can be provided with user notifications 331 to remind them of their roles, important actions, distribution and collection of records 324 and prompt each role for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For medication management, a protocol for one specific therapy example created for one user can be used by many users across future periods of time. This ensures that patients are advised of user notification 331. Using smart-alerts 332 and user responses 333 received by fixed and mobile devices 170, patients are able to collect and log important information. Relevant examples of such information include test results, reports, dates of expiry of medications, symptoms, pain levels, date of next appointment or treatment, amount of stock of medication at hand by the user, and dates that other related tasks need to conducted, such as the need for prescriptions to ensure that prescribed medications are not disrupted. An event 210 or schedule 220 can also be configured for interacting with each therapy, e.g. for medications, to track the maximum period that medication can be administered, and adjusting dosages depending on rule interactions. Schedules 220 and records 324 can be searched by the user and shared with health professionals or any other user, either on a temporary or perpetual basis.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for therapy management or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment of the patent in therapy management and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: education community. This example may apply to user profile details such year of study, age, interest, optional study, tutorials, project allocation, common purpose or specific participation requirement. This embodiment also encapsulates related embodiments including templates for the entire academic community, either applying to all of the community or a subset of that community, such as student body, parents, guardians, teacher, administration, support staff and volunteer.

Referring to FIG. 6 for the education community embodiment, the method 600 uses events and timing information which administrators, coordinators, users or any another advisor as applicable to each user's specific need. The method 600 commences processing at step 610 (“Start”). In step 620, reusable non-user-specific templates are constructed by users, including administrators, co-ordinators, advisors, or users, as described in greater detail hereinafter with reference to FIGS. 1-5. Each template comprises for each education community sequence an event, a notification, and an associated data record stored in a database repository accessible via an electronic network coupled to the time management system. Examples of records include date of events, dates for preparation and follow-up, information related to the progressions of events for that sequence, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progression of events for that education community, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For education communities, rosters may be used to manage the various roles between the co-ordinator and other users in the community with examples including student, teacher, tutor, volunteer, attendee, guest, delegate, lecturer, facility manager, caterer, examiner, umpire, marshaller, administrator, secretary or any other user activity in that community. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the education community embodiment, records include date of events, dates for preparation and follow-up, information related to the progression of events for that sequence, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's role in the education community. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: academic, governance, sports, volunteer, curriculum, tutorials, exam, project, group work or any other situation associated with the education community as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. One embodiment of smart-alerts enable feedback and control of wearable devices which deliver notification text, provide vibration, and allow for user responses.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: academic, governance, sports, volunteer, curriculum, tutorials, exam, project, group work or any other situation associated with the education community as per those events in the schedule.

Examples of records include birth date, gender, address, location of the user's mobile device, current year of study, examination results/certificates, sports results, reports, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose, and may include: academic, governance, sports, volunteer, curriculum, tutorials, exam, project, group work or any other situation associated with the education community as per those events in the roster.

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, academic, governance, sports, volunteer, curriculum, tutorials, exam, project, group work or any other situation associated with the education community and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for an education community is established by using an event 111 for each scheduled activity, which may be repeated, or dynamically sequenced depending upon other events for the user or another user. Each role within the education community may be notified by the recommendation engine 182 relating to user responses 333 in accordance with each rule 100.

For each role in the education community, for example, all participants can be provided with user notifications 331 to remind each role of important actions, distribution and collection of records 324 and prompt each participant for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For the education community, a protocol for one subject curriculum created by a co-ordinator or user for one user can be used by many users across future periods of time. This ensures that participants are advised of user notifications 331. Using smart-alerts 332 and user responses 333 received by fixed and mobile devices 170, participants are able to collect and log important information. Relevant examples of such information include assignments, test results, reports, important dates, tutorials, project meetings, collaboration interaction and dates that other related tasks that need to conducted.

An event 210 or schedule 220 can also be configured for interacting with group within the education community, e.g. group assignments, collaborations, social interactions, etc., each schedule or roster adjusting depending on rule interactions. Schedules 220 and records 324 can be searched by the user and shared with other members in the education community.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for the education community or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment in education communities and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: sports community. This example may apply to users who are spectators, participants, umpires, game official, trainers, support staff, volunteers, catering staff, transport providers, dignitaries and those who are responsible for managing the facilities and resources required for that sport. This embodiment also encapsulates related embodiments including templates for competition games, training, multi-sports events, touring, social occasions, and administration planning.

Referring to FIG. 6 for the sports community embodiment, the method 600 uses events and timing information which spectators, participants, umpires, game official, trainers, support staff, volunteers, catering staff, transport providers, dignitaries and those who are responsible for managing the facilities and resources required for that sport as applicable to each user's specific need. The method 600 commences processing at step 610 (“Start”). In step 620, reusable non-user-specific templates are constructed by users, including administrators, co-ordinators, advisors, or users, as described in greater detail hereinafter with reference to FIGS. 1-5. Each template comprises for each sports community sequence an event, a notification, and an associated data record stored in a database repository accessible via an electronic network coupled to the time management system. Examples of records include date of events, dates for preparation and follow-up, information related to the progression of events for that sequence, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progressions of events for that sports community, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For sports communities, rosters may be used to manage the various roles between the co-ordinator and other users in the community with examples including spectators, participants, umpires, game official, trainers, support staff, volunteers, catering staff, transport providers, dignitaries and those who are responsible for managing the facilities and resources required for that sport. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the sports community embodiment, records include date of events, dates for preparation and follow-up, information related to the progression of events for that sequence, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's role in the sports community. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: competition games, training, multi-sports events, touring, social occasions, administration or any other situation associated with the sports community as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes, and user responses such as adjusting for scores, or other statistical details, at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: competition games, training, multi-sports events, touring, social occasions, administration or any other situation associated with the sports community as per those events in the schedule

Examples of records include birth date, gender, address, location of the user's mobile device, current team and grade classification, competition results, sports results, reports, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: competition games, training, multi-sports events, touring, social occasions, administration or any other situation associated with the sports community as per those events in the roster

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, competition games, training, multi-sports events, touring, social occasions, administration or any other situation associated with the sports community as per those events in the roster and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for a sports community is established by using an event 111 for each scheduled activity, which may be repeated, or dynamically sequenced depending upon other events for the user or another user. Each role within the sports community may be notified by the recommendation engine 182 relating to user responses 333 in accordance with each rule 100.

For each role in the sports community, for example, all participants can be provided with user notifications 331 to remind each role of important actions, distribution and collection of records 324 and prompt each participant for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For a sports community a season of events for one team created by a coach, trainer, manager or user can be used on many occasions by many other team across future periods of time. This ensures that participants are advised of user notifications 331. Using smart-alerts 332 and user responses 333 received by fixed and mobile devices 170, participants are able to collect and log important information. Relevant examples of such information include player positions, confirmation, reserves for games, official roles, catering and support staff.

An event 210 or schedule 220 can also be configured for interacting with other teams within the sports community as may be the case for finals series e.g. allocation of position, official roles, financial statements, social interactions, etc., each schedule or roster adjusting depending on rule interactions. Schedules 220 and records 324 can be searched by the user and shared with other members in the community involved with that team.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for the sports community or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment in sports communities and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: meeting management. This example may apply to meeting participants, official meeting roles, use of facilities and resources required for that particular meeting. This embodiment also encapsulates related embodiments including templates for formal meetings, social events, project management, not-for-profit administration, general administration in any field, work programs, or any other application where roles, resources and outcomes may be factors in a successful outcome for a meeting.

Referring to FIG. 6 for meeting management embodiments, the method 600 uses events and timing information which meeting participants, official meeting roles, use of facilities and resources required for that particular meeting. as applicable to each user's specific need. The method 600 commences processing at step 610 (“Start”). In step 620, reusable non-user-specific templates are constructed by users, including administrators, co-ordinators, advisors, or users, as described in greater detail hereinafter with reference to FIGS. 1-5. Each template comprises for each meeting management sequence an event, a notification, and an associated data record stored in a database repository accessible via an electronic network coupled to the time management system. Examples of records include date of events, dates for preparation and follow-up, information related to the progression of events for that sequence, content of questions and responses to answers, agenda for meetings, minutes of meetings, reports, action plans, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progression of event for the community involved with a specific meeting, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For communities involved with meetings, rosters may be used to manage the various roles between the co-ordinator and other users in the meeting community with examples including meeting participants, official meeting roles, use of facilities and resources required for that particular meeting. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For the meeting management embodiment, records include date of events, dates for preparation and follow-up, information related to the progression of events for that sequence, content of questions and responses to answers, agenda for meetings, minutes of meetings, reports, action plans, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's role in the community of users involved in that meeting. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: formal meetings, social events, project management, not-for-profit administration, governance, routine meetings, general administration in any field, work programs, meetings of officials and participant, symposium or any other situation associated with meeting management as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses such as voting at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: formal meetings, social events, project management, not-for-profit administration, governance, routine meetings, general administration in any field, work programs, meetings of officials and participant, symposium or any other situation associated with meeting management as per those events in the schedule

Examples of records include minutes of meeting, agenda, outcomes, project milestones, reports, certificates, official documentation, correspondence, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: formal meetings, social events, project management, not-for-profit administration, governance, routine meetings, general administration in any field, work programs, meetings of officials and participant, symposium or any other situation associated with meeting management as per those events in the roster

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, immunisations, community health care, personal development monitoring, health checks and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for meeting management is established by using an event 111 for each scheduled activity, which may be repeated, or dynamically sequenced depending upon other events for the user or another user. Each role for the specific meeting community may be notified by the recommendation engine 182 relating to user responses 333 in accordance with each rule 100.

For each role in the meeting community, for example, all participants can be provided with user notifications 331 to remind each role of important actions, distribution and collection of records 324 and prompt each participant for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For meeting management, a protocol for one group of participants created by a co-ordinator or user can be used on many occasions by many other user groups across future periods of time. This ensures that participants are advised of user notifications 331. Using smart-alerts 332 and user responses 333 received by fixed and mobile devices 170, participants are able to collect and log important information. Relevant examples of such information include agenda, meeting minutes, progress reports, correspondence, collaboration interactions and dates that other related tasks that need to conducted.

An event 210 or schedule 220 can also be configured for interacting with group within the community applicable to that meeting, e.g. allocation of roles and actions, progress in the completion of actions, reports, financial statements, governance processes, group work collaborations, social interactions, etc., each schedule or roster adjusting depending on rule interactions. Schedules 220 and records 324 can be searched by the user and shared with other members in the community involved with each meeting.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for meeting management or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment in meeting management and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: travel or group travel. This example may apply to travel participants including the tourist, tour organiser, tour guide, transport operators, caterers, hoteliers and any combination of air, bus, train, taxi or private operator. This embodiment also encapsulates related embodiments including tour options, management of symposium travel and events, preparatory schedules, timetables and other temporal related plan.

Referring to FIG. 6 for travel embodiments, the method 600 uses events and timing information for a tourist, tour organiser, tour guide, transport operators, caterers, hoteliers and any combination of air, bus, train, taxi or private operator as applicable to each user's specific need. The method 600 commences processing at step 610 (“Start”). In step 620, reusable non-user-specific templates are constructed by users, including administrators, co-ordinators, advisors, or users, as described in greater detail hereinafter with reference to FIGS. 1-5. Each template comprises for each travel sequence an event, a notification, and an associated data record stored in a database repository accessible via an electronic network coupled to the time management system. Examples of records include itineraries, directions, payment dates, date of events, dates for preparation and follow-up, information related to the progression of events for that sequence, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progressions of events for travel arrangements, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For travel embodiments, rosters may be used to manage the various roles between the co-ordinator and other users in the community with examples including tourist, tour organiser, tour guide, transport operators, caterers, hoteliers and any combination of air, bus, train, taxi or private operator as applicable to each user's specific need. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For travel embodiments, records include itineraries, directions, payment dates, date of events, dates for preparation and follow-up, information related to the progression of events for that sequence, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's role in the travel community. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: tour itinerary, group itinerary, optional tourist activities, optional catering options, optional transport alternatives, administration of tourists, financial interactions, as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses such as advising choices at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: tour itinerary, group itinerary, optional tourist activities, optional catering options, optional transport alternatives, administration of tourists, financial interactions, as per those events in the schedule

Examples of records include birth date, gender, address, location of the user's mobile device, identification records, passport details, driver's license, visas, itinerary, catering plans, documentation, correspondence, receipts, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: tour itinerary, group itinerary, optional tourist activities, optional catering options, optional transport alternatives, administration of tourists, financial interactions, as per those events in the schedule

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, tour itinerary, group itinerary, optional tourist activities, optional catering options, optional transport alternatives, administration of tourists, financial interactions and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for travel is established by using an event 111 for each scheduled activity, which may be repeated, or dynamically sequenced depending upon other events for the user or another user. Each role for the specific travel community may be notified by the recommendation engine 182 relating to user responses 333 in accordance with each rule 100.

For each role in the travel community, for example, all participants can be provided with user notifications 331 to remind each role of important actions, distribution and collection of records 324 and prompt each participant for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For travel, an itinerary for one group of tourists created by a co-ordinator such as a travel agent, tour guide or user can be used on many occasions by many other tours across future periods of time. This ensures that participants are advised of user notifications 331. Using smart-alerts 332 and user responses 333 received by fixed and mobile devices 170, participants are able to collect and log important information. Relevant examples of such information include itineraries, details of travel bookings, confirmations, transport instructions, travel time, interactions and dates that other related tasks that need to be conducted.

An event 210 or schedule 220 can also be configured for interacting with group within the community applicable to each tour e.g. allocation of roles and provision of travel services, financial statements, social interactions, restaurant booking, etc., each schedule or roster adjusting depending on rule interactions. Schedules 220 and records 324 can be searched by the user and shared with other members in the community involved with that tour.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for travel or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment in travel and related applications, but modifications and/or changes can be made thereto without departing from the scope of the invention. The embodiments of the embodiment are illustrative and not restrictive.

Embodiments of the service comprise a method of creating templates by a user, then using that template by either that user, or another user. This example illustrates the method of embodiment for the following: church community. This example may apply to users who are members of the congregation, religious leaders, support staff, volunteers, catering staff, transport providers, musicians, dignitaries and those who are responsible for managing the facilities and resources required for that church or any activity that the church community is involved in. This embodiment also encapsulates related embodiments including templates for church services, marriage, baptism, social event, youth group, fund raiser, mission or any other activity that the church community is involved in.

Referring to FIG. 6 for church community embodiments, the method 600 uses events and timing information which members of the congregation, religious leaders, support staff, volunteers, catering staff, transport providers, musicians, dignitaries and those who are responsible for managing the facilities and resources required for that church or any activity that the church community is involved in as applicable to each user's specific need. The method 600 commences processing at step 610 (“Start”). In step 620, reusable non-user-specific templates are constructed by users, including administrators, co-ordinators, advisors, or users, as described in greater detail hereinafter with reference to FIGS. 1-5. Each template comprises for each church community sequence an event, a notification, and an associated data record stored in a database repository accessible via an electronic network coupled to the time management system. Examples of records include date of events, dates for preparation and follow-up, information related to the progression of events for that sequence, content of questions and responses to answers, addresses, maps, url links, media relating to events, advisory text as well as user created records which can be added for storage of information. Each template is a combination of records in a database repository with fields that relate one record type to another record type. In step 630, at least one rule is included (defined) in each template. Each rule creates a temporal relationship between (1) two or more events, or (2) an event and an associated data record, to form at least one dynamic interrelated event schedule. Examples of rules may relate to the timing between the progressions of events for that church community, particularly when events are missed, and there is a pre-determined constraint on when the next related event in the sequence or any sequence of events that requires definition such as repeats or any other specific periods between those events. In step 640, templates are instantiated by populating the records of the templates with data to create at least one user-specific event schedule, or a multiple role roster, each having associated records. For church communities, rosters may be used to manage the various roles between the co-ordinator and other users in the community with examples including members of the congregation, religious leaders, support staff, volunteers, catering staff, transport providers, musicians, dignitaries and those who are responsible for managing the facilities and resources required for that church or any activity that the church community. Each roster is a set of interrelated event schedules for multiple user roles. In step 650, event notification alert temporal data is monitored and at least one user device is notified in response to the monitoring by initiating a smart-alert. The smart-alert comprises a notification regarding an event in one or more schedules that require a reply from a user device connected to the electronic network with user information to satisfy the rule associated with the smart-alert. The requested information is stored in the associated data record. In step 660, the reply to the smart-alert, comprising data to update the associated data record, is received from a user (mobile or fixed) device (e.g. a personal computer, a laptop computer, a tablet computer, a smartphone, a network accessible computer). For church community embodiments, records include date of events, dates for preparation and follow-up, information related to the progression of events for that sequence, content of questions and responses to answers, addresses, maps, url links, media relating to events, advisory text as well as user created records which can be added for storage of information. In step 670, based on a change to or adding of user data in the associated data record, a rule, an event, a role, a data record, and/or a notification is changed. Processing then ends or returns in step 680. This results in the smart-alert notifications being delivered, and personalised for each user's role in the church community. The steps 620 to 670 may be repeatedly performed by use of an appropriate loop, or the method 600 may be repeatedly performed as required.

The embodiments of the invention enable users to manage a schedule of predefined time critical events and associated records by creating templates, which contain sequences of temporal events related by rules. These templates and rules can be used and reused multiple times. The rules create relationships between events within the same schedule, and/or between events within schedules that belong to the same user or multiple users. These templates allow users to instantiate their own independent copy of the schedule of events and if required customise the schedule of events to their requirements without changing the original schedule template.

Because rules can apply across multiple schedules for a single user, interdependent schedule templates can be created for management of complex temporal activities, such as but not limited to: church services, marriage, baptism, social event, youth group, fund raiser, mission or any other activity that the church community is involved in as per those events in the schedule or roster which defines the specific details of this embodiment.

The rules can contain any logical expression and can trigger events such as creating new records or smart-alerts. The rules can also refer to fields with stored records which enables the schedules to respond to and be modified by external input. Therefore making the schedules dynamic and changing automatically to external input.

Temporal data in schedules, rules and records can be absolute, relative to other events or stored data records via rules, or entered manually or automatically when the template is instantiated. Smart-alerts associated with the temporal events enables users to not only be notified of events but also allow users to manually or automatically enter data that is associated with the event alert that can be stored in records and used for temporal relationships or event triggers. A related embodiment of smart-alerts enables notifications to users via wearable devices such blue tooth connected devices providing text messages, vibrations, enrolment of photos or voice notes and user responses at the time of notification.

Event Alerts can be pre-event, upon event, or post event. Multiple alerts within a defined timeframe can be aggregated into a single alert and can be acknowledged by a single acknowledgement to reduce user disruption.

Templates and instantiated schedules can be viewed in either the time domain or in a spatial relationship domain to facilitate, creation, editing, and viewing.

The event may be in at least one schedule of events of at least one user. The temporal relationships defined in the templates may each comprise a combination of absolute, relative, calculated, and user-defined temporal relationship.

For this embodiment example, schedules are created for each specific intended purpose, and may include: church services, marriage, baptism, social event, youth group, fund raiser, mission or any other activity that the church community is involved in as per those events in the schedule.

Examples of records include scripture references, run sheet for each service, location of the user's mobile device, certificates of baptism, marriage, records of donations, other receipts, catering plans, documentation, correspondence, photos, voicemail, video, calculated travel time, or any other record type which is referenced in the specific schedule example of this embodiment.

By way of example of the method used in the embodiment of embodiments, and relating back to the description previously recorded, schedules 110 are created by linking more than one event 111 using rules and embedding data records 140 either associated with the whole schedule 110, or linked to an individual event 111. Schedules 110 once created as user instantiated templates (320 in FIG. 3) are processed by the rule engine 120 and recommendation engine 182. Event triggers 125 initiate smart-alerts 130, which generate user notifications (331 in FIG. 3). Smart-alerts 130 initiate user responses 333, which are either stored in user records 324 or locally on the user device 330 if that device is not connected to the electronic network. Once an electronic network is re-established, user responses 333 are transferred to user records 324.

Smart-alert responses 333 can also generate event triggers 125 to initiate other user events 321, user schedules or user rosters, either for that user or any other designated user by the rule engine 120, which processes the user instantiated templates 320.

Users are tracked via the administration engine 180 engine, using user information and contact lists for candidate users, which have not yet subscribed. Related information is stored in data records 140.

The user can create published templates 300 from a user template 310, by identifying the fields in the template that are required to be populated with user or instantiation data at the time of instantiation. The instantiation relationship between published templates 300, user templates 310, and user instantiated template 320 is tracked so that subsequent updates of a published template 300 can flow through to user templates 310 and user instantiated templates 320 providing that related user responses 333 are authorised for updating by the user for each update.

For an existing published template 300, a user selects published templates 300 and replicates those published templates 300 into user templates 310. To prepare for processing of the template by the rule engine 120 and the recommendation engine 182, the user data 324 is added either using available information in the user records 324 to automatically populate fields required for the instantiation, or the user is required to enter additional data which is not available in the user records 324. Once all fields are entered, and other important data held by the system 100 is added, such as time zone and location, the middle-tier user templates 310 are instantiated to create lower-tier user instantiated templates 320. The middle-tier user templates 310 include user event templates 311, user schedule templates 312, user roster templates 313, and user record templates 314.

At the time of instantiation, associated template data is transferred 421, 422, 423 to user rosters 430, user schedules 440 and user events 450. Notifications interact with the local apps 558 on fixed and mobile devices 410, 560 as well as through standard iCalendar notifications 414. Settings are available on the fixed or mobile device 410 to transfer user records instance 424 to local data storage cache 411, so that this media is available when the electronic network is disconnected. If the device 410 is connected to an electronic network, user records instances 424 can be retrieved ether by links embedded in standard iCalendar notification transactions or through system interactions with the app or processing instance that is processing on the fixed or mobile device 410.

Data in user record templates 515 can also be utilised in rules and as smart-alert responses allowing users to update data, resulting in dynamic sequencing that can be initiated by changes in user records 535, once user instantiated templates have been created and linked to create rule field values.

As a further example of the embodiments of the embodiment, the following text is repeated:

For rosters 280, the top-tier published user-roster templates 303 can be created from a user roster template 313, by identifying the fields in the template that are required to be populated with user or instantiation data at the time of instantiation, if any. Users can replicate published templates 300 versions of user roster templates 303 into user templates 310. To prepare for processing of templates, user data is added using either available information in user records 324 to automatically populate fields required for the instantiation or the user is required to enter additional data that is not available in the user records 324. Once all fields are entered, middle-tier user templates 310 versions of user roster templates 313 are instantiated to create lower-tier user-instantiated templates 320 versions of user rosters templates 323, which are processed by the rule engine 120 and recommendation engine 182.

For this embodiment example, rosters are created for each specific intended purpose along with the nominated role allocations and the selection of resources. Examples may include: church services, marriage, baptism, social event, youth group, fund raiser, mission or any other activity that the church community is involved in as per those events in the roster.

User instantiated templates 320, which comprise user event 321, user schedules 322, user rosters 323, and user records 324, are processed by the rule engine 120 to initiate user notifications 331, event triggers 125 and user smart-alerts 332. User responses 333 may result in updating of user records 324.

The embodiments of the invention have application to, but are not limited to, church services, marriage, baptism, social event, youth group, fund raiser, mission and any other related event which is added to the specific schedule or roster.

In these cases, important information and media is loaded into the data records 140 repository. If updates of this information are needed, user templates 310 and published templates 300 can be created. Events 210 are configured individually or as schedules 220.

Event templates can be instantiated in at least one schedule of events of at least one user.

Interactions between events 210 of one user or between events of different users 250 are cross referenced, and the attributes of rules are added to define those interactions. Data is stored as data records 140 for processing by the rule engine 120 and recommendation engine 182.

A sequence for the church community is established by using an event 111 for each scheduled activity, which may be repeated, or dynamically sequenced depending upon other events for the user or another user. Each role for the specific church community may be notified by the recommendation engine 182 relating to user responses 333 in accordance with each rule 100.

For each role in the church community, for example, all participants can be provided with user notifications 331 to remind each role of important actions, distribution and collection of records 324 and prompt each participant for feedback on progress of tasks via the user responses 333.

Calendars and schedules of events can be converted into user templates 310 and published templates 300, which may be selected by different groups of users, and processed by the system according to user requirements and other instantiation data at the time or instantiation into the user instantiated templates 320. In this manner, schedules that may be used in one period can be reapplied across future periods of time, thereby reducing the complexity of administration and increasing productivity of administrators and students.

For a church community, a set of events for one type of church service for one group of parishioners created by a co-ordinator in the church, or any other user in the church community can be used on many occasions for other church services across future periods of time, and with different church goers. This ensures that parishioners are advised of user notifications 331. Using smart-alerts 332 and user responses 333 received by fixed and mobile devices 170, participants are able to collect and log important information. Relevant examples of such information include the sequence of church services, confirmations, preparation, transport instructions, travel time, interactions and dates that other related tasks that need to be conducted.

An event 210 or schedule 220 can also be configured for interacting with group within the community applicable to each tour e.g. allocation of roles and provision of travel services, financial statements, social interactions, restaurant booking, etc., each schedule or roster adjusting depending on rule interactions. Schedules 220 and records 324 can be searched by the user and shared with other members in the community involved with that tour.

Based upon the location and time zone attributes of an event 210 along with other system and publicly available or licensed travel time data, the rule engine 120 and recommendation engine 182 can incorporate travel time and adjust user notifications to dynamically process user notifications 331, to ensure that all participants are able to attend on time at an agreed location or at the same time. In a similar manner, for the church embodiment or any of the related examples, a phone conference can be scheduled for participants in different time zones, ensuring that each participant's user notifications 331 are adjusted for time of day across the varying time zones.

The method of managing scheduled events in a network-hosted time management system may alternatively be implemented in dedicated hardware such as one or more integrated circuits performing the functions or sub functions of managing scheduled events in a network-hosted time management system. Such dedicated hardware may include graphic processors, digital signal processors, or one or more microprocessors and associated memories.

Methods, apparatuses, and computer readable media for managing scheduled events in a network-hosted time management system implemented using a computer system have been disclosed. The foregoing relates to the embodiment in church community and related applications, but modifications and/or changes can be made thereto without departing from the scope of the invention. The embodiments of the embodiment are illustrative and not restrictive.

1-34. (canceled)

35. A method for managing scheduled events in a network-hosted time management system implemented using a computer system, the method comprising:
constructing reusable non-user-specific schedule templates each comprising an event, a notification, and an associated data record stored in a database repository accessible via an electronic network coupled to said time management system, each template being a combination of records in a database repository with fields that relate one record type to another record type;
including, in each template, at least one rule, each rule creating a temporal relationship between at least two events, or an event and an associated data record, to form at least one dynamic interrelated event schedule;
instantiating templates by populating said records of said templates with data to create at least one user-specific event schedule, or a multiple role roster, each having associated records, each roster being a set of interrelated event schedules for multiple user roles;
monitoring event notification alert temporal data and notifying at least one user device by initiating a smart alert, said smart-alert comprising a notification regarding an event in at least one schedule that requires a reply from a user device connected to the electronic network with user information to satisfy the rule associated with the smart-alert, the smart alert prompting a user to operate the at least one user device to enter data that is associated with the event for at least one of temporal relationships and an event trigger, said requested information being stored in the associated data record;
receiving from a user device a reply to the smart-alert comprising data to update the associated data record; and
based on a change to data in said associated data record, changing at least one of:
a schedule,
a rule,
an event,
a role,
a data record, and
a notification.

36. The method as claimed in claim 35, wherein the event is in at least one schedule of events of at least one user and the template is recommended to a user based on a user attribute, activity, or current location of the user device.

37. The method as claimed in claim 35, comprising:
caching instantiated templates and associated data records in at least one local storage device of an electronic device that can access the electronic network for issuing a smart-alert when said electronic device is disconnected from the network-hosted time management system;
storing a reply to said smart-alert on said local storage device until said electronic device is connected to the network-hosted time management system; and
transferring said reply to said smart-alert to the network-hosted time management system.

38. The method as claimed in claim 36, wherein based on the location of the user device, the at least one of the schedule, the rule, the event, the role, the data record and the notification is modified in accordance with at least one of a national, state and local jurisdiction health-related requirement and a health advisory body recommendation.

39. The method as claimed in claim 38, wherein:
the reusable non-user specific schedule templates are constructed by at least one of health administrators, health advisers and user;
at least one of the non-user specific schedule templates comprises a health related event; and
the at least one rule relates the timing between two health related events.

40. The method as claimed in claim 36, comprising the steps of:
instantiating at least one of the reusable non-user specific schedule template by populating the records of the templates with data to create at least one user-specific event schedule, or a multiple role roster; and
using the user-specified event schedule, or the multiple role roster, to manage the health pathway interaction between at least one of health care professionals, nurses, family, friends, advocates and carers;
monitoring event notification alert temporal data and notifying at least one user device in response to the monitoring by initiating a smart alert; and
changing at least one of a rule, an event, a role, a data record, and/or a notification in response to at least one of a change to and an addition to user data in the associated data record.

41. The method as claimed in claim 40, wherein the user-specified event schedule, or the multiple role roster, comprises a set of interrelated event schedules for multiple user roles.

42. The method as claimed in claim 39, wherein the health related event comprises at least one of a vaccination, an immunisation, a health check, a family nurse evaluation, a symptom briefing, media and related information advice, a medication event, a therapy event, and a request for user details; and
the instantiated data records comprise at least one of health status information, immunisation certification information, prescription information, medical report information, and health insurance claim information.

43. A method as claimed in claim 35, wherein the templates and user records are adapted to be categorised, stored, searched, and viewed by system, or user-defined context specific categories and tags.

44. A method as claimed in claim 35, comprising the steps of:
publishing a template by the network-hosted time management system for use by another user;
sharing in part or whole a user's account including any event schedules, templates, and an associated data records between users using permission controls of the network-hosted time management system;
identifying and notifying the user of any conflicts between events in a user's schedules or events in shared schedules from other users and recommending possible changes to those events to avoid or minimise conflict; and
allocating specific users to roster roles.

45. An apparatus for managing scheduled events in a network-hosted time management system implemented using a computer system, the computer system comprising a processing unit and a memory storing data and a computer program, the processing unit and memory configured when executing the computer program to perform a method comprising:
constructing reusable non-user-specific templates each comprising an event, a notification, and an associated data record stored in a database repository accessible via an electronic network coupled to said time management system, each template being a combination of records in a database repository with fields that relate one record type to another record type;
including, in each template, at least one rule, each rule creating a temporal relationship between at least two events, or an event and an associated data record, to form at least one dynamic interrelated event schedule;
instantiating templates by populating said records of said templates with data to create at least one user-specific event schedule, or a multiple role roster, each having associated records, each roster being a set of interrelated event schedules for multiple user roles;
monitoring event notification alert temporal data and notifying at least one user device by initiating a smart alert, said smart-alert comprising a notification regarding an event in at least one schedule that requires a reply from a user device connected to the electronic network with user information to satisfy the rule associated with the smart-alert, the smart alert prompting a user to operate the at least one user device to enter data that is associated with the event for at least one of temporal relationships and an event trigger, said requested information being stored in the associated data record;
receiving from a user device the reply to the smart-alert comprising data to update the associated data record; and
based on a change to data in said associated data record, changing at least one of:
a schedule,
a rule,
an event,
a role,
a data record, and
a notification.

46. A non-transitory computer readable medium having recorded therein a computer program for managing scheduled events in a network-hosted time management system implemented using a computer system, the computer program comprising:
code for constructing reusable non-user-specific templates each comprising an event, a notification, and an associated data record stored in a database repository accessible via an electronic network coupled to said time management system, each template being a combination of records in a database repository with fields that relate one record type to another record type;
code for including, in each template, at least one rule, each rule creating a temporal relationship between at least two events, or an event and an associated data record, to form at least one dynamic interrelated event schedule;
code for instantiating templates by populating said records of said templates with data to create at least one user-specific event schedule, or a multiple role roster, each having associated records, each roster being a set of interrelated event schedules for multiple user roles;
code for monitoring event notification alert temporal data and notifying at least one user device by initiating a smart alert, said smart-alert comprising a notification regarding an event in at least one schedule that requires a reply from a user device connected to the electronic network with user information to satisfy the rule associated with the smart-alert, the smart alert prompting a user to operate the at least one user device to enter data that is associated with the event for at least one of temporal relationships and an event trigger, said requested information being stored in the associated data record;
code for receiving from a user device the reply to the smart-alert comprising data to update the associated data record; and
code for, based on a change to data in said associated data record, changing at least one of:
a schedule,
a rule,
an event,
a role,
a data record, and
a notification.
